(19) United States
(12) Patent Application Publication
(10) Pub. No.: US 2012/0118797 A1
(43) Pub. Date: May 17, 2012

(54) SORTING METHOD AND SORTING CONFIGURATION FOR SORTING TWO TYPES OF ARTICLES TO PRODUCE A SINGLE SUCCESSION

(75) Inventors: Peter Berdelle-Hilge, Konstanz (DE); Nikolaus Haselberger, Radolfzell-Markelfingen (DE); Wolf-Stephan Wilke, Konstanz (DE); Armin Zimmermann, Konstanz (DE)

(73) Assignee: SIEMENS AKTIENGESELLSCHAFT, MUENCHEN (DE)

(21) Appl. No.: 13/300,973

(22) Filed: Nov. 21, 2011

Related U.S. Application Data
(60) Provisional application No. 61/416,577, filed on Nov. 23, 2010.

(30) Foreign Application Priority Data
Nov. 17, 2010 (DE) DE102010044059.0
Dec. 16, 2010 (DE) DE102010063211.2

(51) Int. Cl. B07C 1/10; B07C 3/00

(52) U.S. Cl. 209/552

(57) ABSTRACT

A sorting method and a sorting configuration for sorting two types of articles, particularly two types of flat mail items, on the basis of a prescribed order among the possible values of a prescribed sorting feature. The articles of the first type are sorted on the basis of the order and divided into sequences of sorted articles. A first supply and feed device in a sorting installation takes these sequences to holding apparatuses, so that each holding apparatus contains a respective sequence. A second supply and feed device takes the articles of the second article type to a respective holding apparatus. A transportation device produces a succession of sequences and articles of the second article type and transfers the succession to sorting outputs of the sorting installation. In the sorting outputs all articles have been sorted on the basis of the prescribed order.

### CROSS-REFERENCE TO RELATED APPLICATION

This application claims the benefit, under 35 U.S.C. §119(e), of provisional patent application No. 61/416,577, filed Nov. 23, 2010; this application also claims the priority, under 35 U.S.C. §119, of German patent application No. DE 10 2010 063 211.2, filed Dec. 16, 2010; the prior applications are herewith incorporated by reference in their entirety.

### BACKGROUND OF THE INVENTION

### Field of the Invention

The invention relates to a sorting method and a sorting configuration which are able to sort two types of articles, particularly two types of flat mail items, such that a single succession of articles is formed.

European Patent EP 1894637 B1 and Patent Application Publication US 2008/0060981 A1 describe a sorting installation and a sorting method for sorting large letters and standard letters on the basis of their respective delivery addresses. See, FIG. 1. This sorting installation has x stack locations SG1, SG2, . . . , SGx for large letters, z static letter stack locations SB1, SB2, . . . , SBz and y terminal locations E1, E2, . . . , Ey. The stack locations SG1, . . . , SGx are moved on a closed conveying path by means of a conveyor belt 4 and the terminal locations E1, Ey are moved on a closed conveying path by means of a conveyor belt 10. Some terminal locations E1, E2, . . . are situated beneath the stack locations SG1, . . . , SGx and some terminal locations Eq-Es are respectively situated beneath the letter stack locations SB1, SB2, . . . , SBz. The stack locations SG1, . . . , SGx are able to take in large letters and the letter stack locations SB1, . . . , SBz are able to take in standard letters. Two loading stations 1 and 2 each transfer a large letter into a stack location SG1, . . . , SGx. Each terminal location E1, . . . , Ey has a respective associated delivery address. Each stack location SG1, . . . , SGx releases a respective large letter to the correct terminal location E1, . . . , Ey. A loading station 3 loads the letter stack locations SB1, . . . , SBx with letters which have already been pre-sorted into delivery sequence, each letter stack station SB1, . . . , SBz being filled with one or more standard letters for a respective delivery address. Next, each terminal location E1-Ey is taken below the respective appropriate letter stack location SB1, . . . , SBz and the letters slide from the letter stack location SB1, . . . , SBz onto the respective terminal location E1, . . . , Ey.

U.S. Pat. No. 7,728,246 B2 and U.S. Pat. No. 7,282,658 B2 describe a method and an apparatus for sorting two types of articles. In the exemplary embodiment, standard letters (simply referred to as “letters”) act as the first type of articles and large letters (simply referred to as “flats”) act as the second type. All articles are intended to be sorted on the basis of a prescribed sorting feature, e.g. all mail items on the basis of a prescribed order (“delivery sequence”) among delivery points. First of all, the standard letters are sorted exactly into delivery sequence, preferably in two sorting passes (“two-pass sequencing”). All standard letters which need to be transported to the same delivery point are combined, in one refinement, to produce a respective package. The large letters are also sorted exactly into delivery sequence in two sorting passes. In the first sorting pass, the large letters are sorted separately from the standard letters. In the second sorting pass, each package containing sorted standard letters is transferred into a previously formed stream of large letters at the same respective destination. Following the second sorting pass, a sorted succession of standard letters and large letters is formed. The apparatus described in U.S. Pat. No. 7,728,246 B2 has a plurality of supply devices (“feeders 102a, 104a, 106a”) and a transportation device (“conventional type transporting system 110”). A supply device 102a, 104a, 106a feeds mail items alternately (with “pausing” by a “pausing device”) into the transportation device 110.

U.S. Pat. No. 7,165,377 B2 describes a sorting method and a sorting installation which sorts two types of mail items (large letters and standard letters) exactly into a delivery sequence together. The sorting installation transports the mail items by means of a carousel (“bin carousel 4”), which has a respective receiving component (“bin”) for each destination in the delivery sequence. All mail items for a destination are taken to the associated receiving component. This involves each mail item transiting a closed conveying path and being diverted from this conveying path into the appropriate receiving component by means of a separating filter. Later, each receiving component is emptied. In one refinement, all mail items for a destination are bound together.

German patents Nos. DE 103 05 847 B3 and DE 10 2004 033 564 B3 describe an apparatus for sorting flat mail items. This apparatus has a driven conveying loop having a multiplicity of storage pockets 15 for a respective flat mail item. Beneath the conveying loop there is a succession of buffer stores 16 which are filled from the storage pockets 15. The buffer stores 16 for their part release mail items downward into containers 17 which are open at the top. The containers 17 are situated on a transportation path 11. In one refinement, the conveying loop is moved in the opposite direction to the containers 17 from the transportation path 11.

European published patent application EP 2 095 887 A1 describes a sorting installation for flat mail items. The sorting installation has two loading devices, which fill an input conveying device with mail items, and two unloading devices, which unload an output conveying device. In an overlap region, the input conveying device and the output conveying device overlap. A mail item can then be transferred from the input conveying device to the output conveying device when the mail item is in the overlap region. In an optimized-input mode, both loading devices and one unloading device are activated. In an optimized-output mode, both unloading devices and one loading device are activated. The sorting installation can be switched to and fro between the optimized-input mode and the optimized-output mode.

German patent No. DE 196 25 007 C2 and U.S. Pat. No. 6,703,574 B1 describe a method for sorting mail items in a plurality of sorting passes. In the first sorting pass, for each destination, the number of mail items which need to be transported to this destination is counted. Simulations on a data processing installation ascertain a respective optimized sorting plan for subsequent sorting passes, that is to say a sorting plan which results in an optimum utilization level for the sorting outputs used.

International patent publication WO 2009/072890 A1 and Patent Application Publication US 2010/0256807 A1 describe a sorting installation which is able to sort two different sorts of mail items. The sorting installation has two groups of sorting outputs (“output positions”), namely a first group for the first sort of mail items and a second group for the second sort of mail items. The mail items of the first sort are pre-sorted, and the mail items in the second group are likewise pre-sorted. A sorting output for the first group and a sorting output for the second group are each intermittently allocated the same destination. All mail items of the first type for this destination are transported to the associated sorting output for the first group, and all mail items of the second type for this destination are transported to the associated sorting output for the second group. This allows all mail items of the two different sorts for the same destination to be brought together.

### SUMMARY OF THE INVENTION

It is accordingly an object of the invention to provide a sorting method and sorting configuration for sorting different types of articles to produce a single succession, which overcomes the above-mentioned disadvantages of the heretofore-known devices and methods of this general type and which enables sorting these articles on the basis of a prescribed sorting feature and a prescribed order among the occurring sorting feature values, wherein the sorting is performed more quickly and requires only a sorting configuration of relatively simple design.

With the foregoing and other objects in view there is provided, in accordance with the invention, a method for sorting a plurality of articles on the basis of a prescribed sorting feature, wherein a sorting feature value order among the occurring values of the sorting feature is prescribed, and wherein each article to be sorted belongs either to a first article type or to a second article type depending on a physical property. The method comprises:
providing a sorting installation having:
   at least one supply and feed device, a transportation device; and at least one sorting output;
   the transportation device including a plurality of holding apparatuses, with each holding apparatus enabled to hold at least one article to be sorted; and enabled to release all held articles at once;
measuring for each article to be sorted the value which the sorting feature assumes for this article;
supplying each article to be sorted to the sorting installation using a supply and feed device and taking to a holding apparatus or intermittently connecting to the holding apparatus in another way;
selecting, for each holding apparatus that is filled with at least one article to be sorted, a sorting output of the sorting installation depending on the measured sorting feature value of an article in the holding apparatus;
taking each filled holding apparatus with the transportation device to a transfer position for the selected sorting output; and
taking all articles from this holding apparatus to the selected sorting output and thereby transferring out to the selected sorting output;
performing an outward transfer such that in each sorting output used a respective article succession of articles is produced which have been sorted on the basis of the sorting feature value order;
and further:
producing a plurality of sequences of articles of the first article type such that
   each article of the first article type belongs to a respective sequence;
   each sequence comprises at least one article of the first article type; and
   the articles in a sequence all belong to the first article type,
producing each sequence containing articles of the first article type such that the articles within this sequence are sorted on the basis of the prescribed sorting feature value order;
wherein at least one sequence includes at least two articles with a matching sorting feature value or two articles with two sorting feature values that occur in direct succession in the sorting feature value order;
taking all sequences of articles of the first article type and all articles to be sorted of the second article type to holding apparatuses such that, when they have been taken, each filled holding apparatus contains:
   a respective sequence of articles of the first article type or
   at least one respective article of the second article type;
transferring all articles in a sequence out to the same sorting output.

With the above and other objects in view there is also provided, in accordance with the invention, a configuration for sorting a plurality of articles based on a prescribed sorting feature, wherein a sorting feature value order among the occurring values of the sorting feature is prescribed, and each article to be sorted belongs either to a first article type or to a second article type depending on a physical property thereof. The configuration comprises:
a measuring device, a sorting installation, and a sequence production device;
the sorting installation including at least one supply and feed device, a transportation device, and at least one sorting output;
the transportation device having a plurality of holding apparatuses each configured:
   to intermittently take in at least one article to be sorted or to intermittently hold the at least one article in another way; and
   to release all held articles at once;
the measuring device being configured to measure, for an article to be sorted, the value assumed by the sorting feature for the article;
each supply and feed device being configured to take articles to be sorted to holding apparatuses or to intermittently connect the articles to holding apparatuses in another way;
the sequence production device being configured to produce a plurality of sequences of articles of the first article type such that
   each sequence includes at least one article of the first article type;
   the articles in each sequence are inherently sorted on the basis of the sorting feature value order; and
   each article in each sequence belongs to the first article type,
wherein the configuration is configured to perform, for each article to be sorted, the following steps:
   measuring, with the measuring device, the value which the sorting feature assumes for the respective article, and
   using a supply and feed device, supplying the article to the sorting installation and taking the article to a holding apparatus or to intermittently connect the article to the holding apparatus in another way;
wherein the configuration is further configured to select, for each holding apparatus that is filled with at least one article to be sorted, a sorting output of the sorting installation depending on the measured sorting feature value of an article in the respective holding apparatus;
the transportation device being configured to take each filled holding apparatus to a transfer position for the selected sorting output;
wherein the configuration is further configured to take all articles from a respective the holding apparatus that is in a transfer position for a selected sorting output to the sorting output and thereby to transfer them out to the selected sorting output;
wherein the configuration is configured to perform the outward transfer of the articles to be sorted such that in each sorting output used a respective article succession of articles to be sorted which have been sorted on the basis of the sorting feature value order is produced;
wherein the configuration is also configured to use the sequence production device to split the articles to be sorted of the first article type into sorted sequences, such that
   each article to be sorted of the first article type belongs to a sequence; and
   at least one sequence produced comprises at least two articles with a matching sorting feature value or two articles with two sorting feature values which occur in direct succession in the sorting feature value order;
wherein the configuration is also configured to use the at least one supply and feed device to take all produced sequences of articles of the first article type and all articles to be sorted of the second article type to holding apparatuses such that, when they have been taken, each filled holding apparatus contains
   a respective sequence of articles of the first article type, or
   a respective at least one article to be sorted of the second article type;
wherein the configuration is also configured to transfer articles to be sorted out to sorting outputs such that, after the outward transfer, all articles in a sequence are situated in the same sorting output.

In other words, a sorting feature on the basis of which the articles need to be sorted is prescribed. In addition, an order among occurring values of this sorting feature is prescribed. This order comprises at least each sorting feature value which is actually assumed by at least one article to be sorted. It is possible for the prescribed sorting feature value order to comprise all possible sorting feature values or at least additionally at least one sorting feature value which is not actually assumed by any article to be sorted. It is also possible for the order to comprise all values which the sorting feature is able to assume.

Each article to be sorted belongs either to a first article type or to a second article type. Each article to be sorted is thus treated either as an article of the first article type or as an article of the second article type.

The article type to which an article belongs depends on at least one prescribed physical property. The articles of the second article type have the or each prescribed physical property. Each article of the first article type does not have at least one prescribed physical property. The physical property may be the sorting feature on the basis of which the articles are to be sorted, or a different physical variable.

The sorting configuration according to the invention comprises

a measuring device;

a sorting installation; and

a sequence production device.

The sorting installation used comprises

at least one supply and feed device,

a transportation device and

at least one sorting output.

The transportation device comprises a plurality of holding apparatuses. Each holding apparatus is able to take in at least one article to be sorted of the second article type or at the same time a sequence containing a plurality of articles of the first article type. The holding apparatus is able to take in a plurality of articles to be sorted of the first article type such that an order—produced prior to taking in—among the articles taken in is maintained. Naturally, a holding apparatus is also able to take in only one article to be sorted of the first article type at a time. Each holding apparatus is able to release the previously taken in articles again. An order is also maintained for the release.

Each holding apparatus is designed such that the holding apparatus is able to release all held articles again only at once but is not able to release a held article and to continue to hold another held article. It is possible for a plurality of holding apparatuses to be mechanically connected to one another, e.g. to produce a moving arrangement with a plurality of compartments, each compartment being able to be opened and closed separately. Each compartment then acts as a holding apparatus.

For each article to be sorted, the measuring device measures the value which the prescribed sorting feature assumes for this article. The measuring device may be part of the sorting installation or else may be implemented outside of the sorting installation. It is possible for at least one first measuring device to be used for the articles to be sorted of the first article type and for at least one second measuring device to be used for the articles to be sorted of the second article type.

The sequence production device produces a plurality of sequences of articles of the first article type. The sequence production is carried out such that the following result is attained:
each article to be sorted of the first article type belongs to exactly one produced sequence.
each produced sequence comprises at least one article of the first article type. A sequence may comprise a plurality of articles of the first article type or else just a single article.
the articles in a sequence all belong to the first article type and are sorted on the basis of the prescribed sorting feature value order within the sequence and thereby put into an order.

No article of the second article type belongs to such a sequence.

At least one sequence comprises two articles of the first article type for which the same sorting feature value has been measured. Alternatively, a first sorting feature value is measured for the one article and a second sorting feature value is measured for the other article. These two sorting feature values follow in direct succession in the prescribed sorting feature value order. This sequence may comprise a further article of the first article type, particularly an article for which this sorting feature value has likewise been measured.

It is possible for a sequence to comprise articles of the first article type with different sorting feature values which are arranged in direct succession in the sorting feature value order.

If these sequences were to be put into the correct order, a succession would arise which comprises exclusively all articles to be sorted of the first article type, wherein all articles of the first article type in this succession have been sorted on the basis of the prescribed sorting feature value order. However, the method according to the solution and the arrangement according to the solution do not require such an overall succession containing all articles of the first article type and no article of the second article type actually to be produced.

At least one first supply and production device takes the thus produced sequences of articles of the first article type to a respective holding apparatus of the transportation device. At least one second supply and production device takes the articles of the second article type to a respective holding apparatus. It is possible for a plurality of supply and feed devices to take articles to holding apparatuses at parallel times or at least at overlapping times.

When these articles have been taken, each holding apparatus in use contains

a respective sequence of articles of the first article type

or

at least one respective article of the second article type.

As a result of the step of taking the sequences containing articles of the first article type and the articles of the second article type to the holding apparatus, holding apparatuses are filled in the transportation device or are taken to the transportation device when they have been filled. The transportation device transports these filled holding apparatuses.

The sorting installation transfers the articles to be sorted in this succession out to the sorting output or to the sorting outputs used in the sorting installation on a step-by-step basis. During the step-by-step outward transfer, the following steps are respectively performed for each holding apparatus with a sequence and for each holding apparatus with an article of the second article type:
for this filled holding apparatus, a sorting output of the sorting installation used is selected. Which sorting output is selected depends on the sorting feature value of the article or on the sorting feature values of the sorted articles in a sequence in this holding apparatus. Even if a plurality of articles with different sorting feature values are taken to the same holding apparatus, a single sorting output is still selected for this filled holding apparatus.
The transportation device takes the filled holding apparatus to a transfer position for the selected sorting output.
The or each article is taken from the filled holding apparatus to the selected sorting output. All articles from a holding apparatus are transferred out to the same sorting output in this case.

The order of outward transfer does not necessarily depend on the succession of the filled holding apparatuses in the transportation device. The outward transfer order also does not necessarily match the sorting feature value order.

These steps are performed for each holding apparatus. In this case, the performance of these steps for a first holding apparatus and the performance of steps for a second holding apparatus are performed in succession or else at overlapping times or even in parallel, depending on the arrangement of these two holding apparatuses in the succession and the arrangement of the sorting outputs in the sorting installation used.

The outward transfer produces a respective article order of articles in each sorting output used in the sorting installation. The articles in the article order in each sorting output used have been sorted on the basis of the sorting feature value order. Usually, each sorting output contains at least one article of the first article type and at least one article of the second article type.

This and a prescribed order among the sorting outputs used mean that, when there are a plurality of sorting outputs, all articles of the first article type and all articles of the second article type have been sorted in a single succession on the basis of the prescribed sorting feature value order.

Particularly by virtue of the buffer stores in the form of holding apparatuses, it is not necessary to sort the articles of the second article type in advance before said articles are combined with the sequences to produce the succession with the filled holding apparatuses. On the contrary, the articles of the second article type can reach the sorting installation in any order, that is to say including at random.

In addition, it is not necessary for the sorting installation to be operated such that an article overtakes another article to be sorted in the sorting installation. In particular, it is not necessary for a filled holding apparatus to overtake another filled holding apparatus. Furthermore, it is not necessary to re-sort articles again after said articles have been transferred out to the same sorting output. In addition, it is not necessary to provide exactly the same number of sorting outputs as sorting feature values. On the contrary, a sorting output is able to take in articles with different sorting feature values. For this, it suffices to take various holding apparatuses to a respective transfer position for the same sorting output in the correct order in succession and then to take the articles in succession from these holding apparatuses to the same sorting output.

It is possible, but not necessary, for the sequences containing articles of the first article type to be put into a particular order before the sequences are supplied to the sorting installation. On the contrary, the invention allows the sequences to be supplied to the first supply and feed device in any order. It is possible, but not necessary, for the sequences to be sorted among one another in advance. It is also possible to supply the sequences to the sorting installation in any, e.g. or random, order instead and to have them taken from the sorting installation to the holding apparatuses in this order. In all of these refinements, the articles in a sequence have been sorted on the basis of the sorting feature value order.

The use of holding apparatuses results in a sorting installation which can be used relatively universally. This sorting installation is able to process articles in various dimensions and nevertheless requires only a single type of holding apparatuses. Each holding apparatus needs to be only large enough for it to be able to take in an article to be sorted of the second article type or a sequence, respectively.

In one refinement, all holding apparatuses used are of the same design. Alternatively, it is possible to use a plurality of different types of holding apparatuses. By way of example, a first type of holding apparatuses is used for the sequences and a second type of holding apparatuses is used for the articles of the second article type. In one refinement, the two types differ in that the first type is able to take in thicker or heavier articles and the second type is able to take in larger articles.

Each holding apparatus is able to release all held articles at once. This allows the holding apparatus to be implemented particularly easily. There is no requirement for a selectively operating restraining element which restrains an article in the holding apparatus while at the same time the holding apparatus releases another article to a sorting output. Such a restraining element requires a sensor system in order to restrain the correct article, and forms a source of error.

According to the solution, a sequence production device is used which puts the articles to be sorted of the first article type into sequences. This sequence production device can be tailored to the articles of the first article type and does not need to be able to process any articles of the second article type. As a result, the sequence production device is able to attain a higher throughput or can be of simpler design or requires less space in comparison with a sequence production device which is able to sort both articles of the first article type and articles of the second article type. By way of example, the physical property which distinguishes the different types of articles is the maximum dimension of an article, and the sequence production device is able to process articles whose maximum dimensions are below a prescribed upper limit.

The invention does not require each sequence to comprise only articles with the same sorting feature value. On the contrary, a sequence is permitted to comprise articles with different sorting feature values, these values being arranged in direct succession in the sorting feature value order. This allows the sorting to require fewer holding apparatuses than a sorting installation in which each holding apparatus takes in only articles with the same sorting feature value. If a sequence comprises articles with different sorting feature values, this sequence is produced such that it is not necessary to insert a further article into the interior of this sequence in order to attain a desired overall succession of sorted articles of both types. In order to attain this desired overall succession, it is always necessary to add a further article only at one end of the sequence.

The invention also does not require each sorting output to have only a single associated sorting feature value. On the contrary, the invention allows at least one sorting output of the sorting installation to be allocated a plurality of sorting feature values and allows a succession of articles with different sorting feature values to be produced in this sorting output, said succession having been sorted on the basis of the sorting feature value order. This succession may comprise a plurality of sequences. Articles of the first article type and articles of the second article type can be transferred out to the same sorting output. It is also possible for articles with different sorting feature values to be transferred out to the same sorting output. These refinements mean that fewer sorting outputs are required than if a separate sorting output needed to be provided for each sorting feature value.

According to the solution, both the sequences and the articles of the second article type are taken to holding apparatuses and transported in these holding apparatuses to the sorting outputs. This allows a single sorting installation to be used for both types of articles and allows both the articles of the first article type and the articles of the second article type to be distributed over the holding apparatuses and then over the sorting outputs. There is no longer any need to use different types of transportation mechanisms for articles of the first article type and for articles of the second article type.

The invention allows an already existing and tried-and-tested sorting installation for articles of the second article type to be adapted with relatively little complexity and such that this existing sorting installation produces the desired succession of sorted articles of both article types. The articles of the second article type are relatively large flat mail items, particularly large letters, for example. A sorting installation which has been tried and tested and can be adapted for implementing the invention is described in German Patents Nos. DE 103 05 847 B3 and DE 10 2004 033 564 B3, for example, and has become known by the name “Open Mail Handling System (OMS)”.

In order to adapt an existing sorting installation for articles of the second article type, either an existing supply and feed device needs to be adapted such that this existing device is additionally also able to feed sequences into holding apparatuses, or a second supply and feed device is added which is able to feed the sequences into holding apparatuses. In addition, a sequence production device is required which needs to sort exclusively articles of the first article type. In the case of flat mail items, this is preferably a sorting installation which is able to sort standard letters into an order among delivery addresses.

An already existing sorting installation for articles of the second article type, e.g. the sorting installation for large letters which is described in German Patents Nos. DE 10305847 B3 or in DE 10 2004 033 564 B3, can continue to be used with relatively little adaptation complexity and can be used to sort additional standard letters. It is necessary to add a sequence production device and a first supply and feed device for the sequences produced. The already existing second supply and feed device and the existing transportation device with the holding apparatuses and the sorting outputs can continue to be used.

The invention can then be applied particularly advantageously when significantly more articles of the first article type than articles of the second article type need to be sorted and the articles of the second article type are more difficult to sort than the articles of the first article type, for example on account of different dimensions, different surface nature and/or greater weight. Particularly the holding apparatuses also allow such articles of the second article type to be sorted easily.

According to the solution, at least one sequence comprises a plurality of articles of the first article type. Between these articles, it is not necessary to insert a further article to be sorted in order to produce the overall succession with all sorted articles. If at least one sequence containing a plurality of articles is fed into the same holding apparatus, sorting the articles requires fewer holding apparatuses than if a separate holding apparatus were to be used for each article. Furthermore, space is saved because a holding apparatus having two articles requires less space than two holding apparatuses having one article each.

The invention therefore allows the holding apparatuses to be exploited to a good degree. This is because a sequence can comprise articles with different sorting feature values and is still taken to the same holding apparatus. This saves holding apparatuses in the transportation device in comparison with the refinement in which a separate holding apparatus is used for each sorting feature value even though a holding apparatus could also simultaneously take in a plurality of articles of the first article type.

In one preferred refinement, a sequence of sorted articles for the first article type is thus treated as a single article to be sorted of the second article type and taken to a single holding apparatus. Only if a sequence is unable to be taken in by a single holding apparatus is the sequence split over a plurality of holding apparatuses. This may be the case particularly if the sequence is too large or too heavy for a single holding apparatus.

In one refinement, a measure of the maximum quantity of articles of the first article type which fit in a holding apparatus at the same time is prescribed. By way of example, this measure is the number, the total thickness, the total weight or another summed physical variable. Each sequence is produced such that the measure for the articles in the sequence is below the limit. It is possible to prescribe a plurality of quantity measures and accordingly a plurality of upper limits.

In another refinement, first of all output sequences of articles of the first article type are produced without necessarily taking account of the capacity of a holding apparatus. The output sequences are produced on the basis of the requirement that the articles in each output sequence are inherently sorted and it is not necessary to insert an article of the second article type into the interior of such an output sequence. Such an output sequence is then treated as a single sequence if all articles in the output sequence fit into a single holding apparatus. Otherwise, the output sequence is split over a plurality of sequences which fit in one respective holding apparatus.

Preferably, the sequences are distributed over as few holding apparatuses as possible, observing the constraint that a further article to be sorted is inserted into the interior of a sequence. In one refinement, whenever the same sorting feature value is measured for a plurality of articles to be sorted of the first article type, at least one sequence is produced which comprises at least two of these articles with an identical sorting feature value. It is possible for a sequence to be produced which comprises three or more articles with an identical sorting feature value. It is also possible for three or more articles with an identical sorting feature value to be distributed over at least two sequences, with at least one sequence comprising two of these articles.

All articles to be sorted in a holding apparatus are transferred out to the same selected sorting output. This allows particularly simple and rapid outward transfer, and the holding apparatus and the sorting output can be of simple design. This would not be possible if the articles needed to be distributed over different sorting outputs upon outward transfer from a holding apparatus.

In one refinement, either an article of the second article type or a sequence of sorted articles of the first article type is taken to each holding apparatus. In another refinement, both an article of the second article type and a sequence are taken to at least one holding apparatus before the holding apparatus is emptied again. As a result, in the holding apparatus, an extended sequence is intermittently formed which comprises the sequence containing articles of the first article type and the article of the second article type. Preferably, the article of the second article type is situated at one end of the sequence, so that the article of the second article type does not need to be inserted into the interior of the sequence. The articles in the extended sequence have also been inherently sorted on the basis of the sorting feature value order and are removed from the holding apparatus in one step.

During normal operation, a respective sorting output is selected for each filled holding apparatus on the basis of the sorting feature value of an article in this holding apparatus. It is possible, instead, for a special sorting output to be selected for a holding apparatus without using this sorting feature value for the selection. This is performed particularly when a fault on the sorting installation prevents regular unloading of the holding apparatus to a selected sorting output and manual maintenance action is required, for example.

In one refinement, the arrangement furthermore comprises a splitting device which is arranged upstream of the sorting installation and of the sequence production device. This splitting device is able to split the articles to be sorted according to the two article types, as a result of which the splitting device forms two sets of articles to be sorted, namely a first set containing all articles of the first article type and a second set containing all articles of the second article type. The first set is transported to the sequence production device, and the second set is transported to the sorting installation. When splitting, the splitting device uses the physical property for each article to be sorted. In one refinement, the measuring device is part of this splitting device.

In one refinement, the sorting installation has at least one all-purpose supply and feed device. This all-purpose device is able to feed both sequences containing articles of the first article type and articles of the second article type into holding apparatuses. It is possible for a plurality of such all-purpose devices to operate in parallel.

Preferably, however, at least two supply and feed devices are used, namely at least one first supply and feed device for the sequences of articles of the first article type and at least one second supply and feed device for the articles of the second article type. Each first supply and feed device thus feeds exclusively sequences of articles of the first article type into holding apparatuses. Each second supply and feed device feeds exclusively articles of the second article type. In addition, a plurality of holding apparatuses are used, to which articles can be taken and, as a result, buffer-stored therein. This allows the two supply and feed devices to operate in parallel. This saves on a “pausing step” and a “pausing device”.

The at least one first supply and feed device is used to supply the previously produced sequences containing articles of the first type to the sorting installation, and the at least one second supply and feed device is used to supply the articles of the second article type. This allows each first supply and feed device to be tailored to articles of the first article type and allows each second supply and feed device to be tailored to articles of the second article type, e.g. in respect of dimensions or processing speed or transportation speed. This often attains a higher throughput than in the case of a single all-purpose supply and feed device. The specialized supply and feed devices require less space than two all-purpose supply and feed devices operating in parallel, which inevitably also need to be large enough for articles of the second article type.

Preferably, the at least one second supply and feed device for the articles of the second article type and the at least one first supply and feed device for the articles of the first article type operate at parallel times or at least at overlapping times. Both supply and feed devices feed articles into the holding apparatuses of the transportation device in the sorting installation. This parallel operation saves time in comparison with a purely sequential procedure.

Preferably, at least one succession of filled holding apparatuses is produced in the transportation device. This succession comprises the sequences containing articles of the first article type and comprises the articles of the second article type in the holding apparatuses. The holding apparatuses have not necessarily already been sorted on the basis of the prescribed sorting feature value order. There may be at least one empty holding apparatus between two filled holding apparatuses in the succession.

Preferably, the sorting installation has a plurality of sorting outputs which are arranged in a logical sorting output order. This logical sorting output order may have been prescribed by a physical arrangement of the sorting outputs in a succession, e.g. in a row or in a closed path, or else by virtue of each sorting output used having an associated position number in an order.

The sorting installation distributes the articles over these sorting outputs such that the sequences are distributed over the sorting outputs and the articles in a sequence have been sorted on the basis of the sorting feature value order. It is not necessary to produce a particular order among the sequences in advance. The articles of the second article type are also distributed over the sorting outputs.

A respective single succession of sorted articles appears in each sorting output. If the articles from the plurality of sorting outputs are assembled on the basis of the sorting output order, a single sorted overall succession containing all articles to be sorted of both article types is produced.

In one refinement, at least one sorting output is firmly associated with each occurring sorting feature value for the entire duration of the sorting. This association thus remains unchanged during sorting. If an associated sorting output is filled with articles up to a prescribed filling level limit, as a result of which no further articles to be sorted can be transferred out to this sorting output, then articles are removed from this filled sorting output, e.g. until the sorting output has been emptied completely. A holding apparatus can now be emptied into this sorting output again. Until this sorting output is available again, the filled holding apparatus remains in the sorting installation—unless a sorting feature value of an article in the holding apparatus additionally has an associated second sorting output and the holding apparatus is emptied in this second sorting output.

In another refinement, during the sorting, the association between a sorting output and a sorting feature value is altered at least once (“dynamic bin allocation”). Although at least one sorting output of the sorting installation is respectively associated with each occurring sorting feature value at any time, conversely at least one sorting output is not associated with a sorting feature value and is intermittently not used. On the contrary, this sorting output is available as a reserve sorting output. If another sorting output has been filled, the sorting feature values of the articles in this filled sorting output are allocated the hitherto free sorting output, that is to say the sorting output which is available in reserve. The filled sorting output is emptied and is then available as a reserve sorting output. The sorting installation may also have a plurality of free reserve sorting outputs at one time. By virtue of the refinement with the at least one free reserve sorting output, time for sorting and/or space in the sorting installation is saved because it is not necessary for a filled holding apparatus to intermittently remain in the sorting installation merely because its content cannot be transferred out to an associated sorting output.

In one refinement, all articles to be sorted are first of all distributed over the holding apparatuses. The articles are then transferred out from the filled holding apparatuses to the sorting outputs. In another refinement, the step of taking the articles to the holding apparatuses is performed at a time overlapping with the step of emptying filled holding apparatuses into sorting outputs. By virtue of the invention, this overlap in time is possible and saves time in comparison with purely serial handling.

Preferably, the transportation device transports the holding apparatuses along a closed conveying path and always in the same transportation direction. A succession containing filled holding apparatuses is preferably produced along this conveying path, and the holding apparatuses are filled and emptied while they are being transported along this conveying path. This reduces the wear on the transportation device and power consumption.

In one refinement, the articles are sorted simply by taking the sequence and the articles of the second article type to the holding apparatuses in a particular time sync. The filled holding apparatuses have then already been sorted on the basis of the prescribed sorting feature value order. This refinement allows rapid outward transfer of the articles from the holding apparatuses to the sorting outputs.

In another refinement, each sequence and each article of the second article type are taken to the respective next available holding apparatus of the transportation device, e.g. to the next free holding apparatus, which is transported past that supply and feed device which will feed the sequence or the article. The order among the articles is first produced in the sorting outputs used. For this, the holding apparatuses are emptied in an order which depends on the sorting feature values of the articles in the holding apparatuses. This refinement allows particularly rapid filling of the holding apparatuses with articles. The holding apparatuses themselves act as a buffer store in which an article remains until it is taken to a transfer position for the respectively selected sorting output.

In one refinement, the sorting installation comprises—apart from the holding apparatuses—a plurality of further buffer stores in addition. Each further buffer store is able to take in at least one article of the first article type or a sequence and is preferably arranged at a fixed location, for example beneath the holding apparatuses and above the sorting outputs. Each filled holding apparatus is taken to a transfer position for a buffer store, and the article or the articles move from the holding apparatus to the buffer store. Next, the respectively selected sorting output of the sorting installation is taken to a transfer position for the buffer store, and the article or the articles move from the buffer store to the selected sorting output. This refinement increases the intake capacity of the sorting installation without needing to increase the number of holding apparatuses or the length of the conveying path of the transportation device and without the space requirement (“footprint”) of the sorting installation increasing. This refinement is advantageous particularly when the articles reach the sorting installation in a quantity which fluctuates over time.

Preferably, at least one sequence is produced such that the sequence comprises articles with a first sorting feature value and comprises articles with a second sorting feature value. These two sorting feature values are arranged in the sorting feature value order in succession such that there is no article of the second article type with a third sorting feature value which is between the first sorting feature value and the second sorting feature value. This makes better use of the holding apparatuses and the articles can nevertheless be sorted as desired. All articles in this one sequence are taken to the same holding apparatus and transferred out from this holding apparatus to the same sorting output. Further articles arrive in the sorting output before or after this sequence. However, it is not possible for the situation to arise in which an article of the second article type still needs to be inserted into the interior of this sequence.

Preferably, for each article to be sorted, the value which the prescribed sorting feature assumes for this article is measured in advance, i.e. before the article is taken to a holding apparatus. This refinement makes it easier to measure the sorting feature value.

Preferably, the sorting installation is additionally used to distribute the articles of the second article type over the sorting outputs of the sorting installation in a preceding sorting process. This refinement allows the sorting installation to perform at least two sorting passes for the articles of the second article type. In order to sort articles on the basis of the sorting feature value order, a plurality of sorting passes are required at least if more different sorting feature values occur than the sorting installation has sorting outputs. This refinement saves time. The second sorting pass for the articles of the second article type is used not only to sort the articles of the second article type but additionally to bring together the sequences of the articles of the first article type with the articles of the second article type and thereby to produce the overall succession of all articles.

Preferably, a data processing installation produces, for each article, a respectively explicit computer-accessible internal identifier which distinguishes said article from all other articles to be sorted. Each internal identifier has the ascertained sorting feature value of the associated article associated with it, e.g. by virtue of the internal identifier and a coding for the measured sorting feature value belonging to the same data record in a central data memory.

Preferably, each holding apparatus is provided with a machine-readable identifier. The data record for an article to be sorted is additionally used to store the identifier of those holding apparatuses to which the article has been taken. This allows the article to be located by ascertaining the position of the holding apparatus with this identifier.

The internal identifiers of all articles to be sorted of both article types are put into a target order such that the order of the internal identifiers in this target order corresponds to the prescribed order among the possible sorting feature values and the associated sorting feature values. This step is performed by computer without touching the articles themselves. The identifiers of the articles of the second article type bound the sequences of articles of the first article type in this target order of all identifiers. This target order among the internal identifiers is used to produce the sequences of articles of the first article type. Each sequence comprises articles of the first article type, the internal identifiers of which occur in direct succession in the target order. Preferably, target sequences of internal identifiers of articles of the first article type are produced, each target sequence being a section of the target order among the internal identifiers. Each target sequence specifies exactly one sequence of articles of the first article type, which is then produced on the basis of the target sequence.

This embodiment implements the advantageous refinement of forming sequences such that some sequences comprise articles with different sorting feature values, i.e. that at least one sequence comprises articles of the first article type with different sorting feature values.

This refinement allows better use to be made of the holding apparatuses, because this sequence has as many articles of the first article type as possible. Time is saved in comparison with a refinement in which each sequence comprises exclusively articles with the same sorting feature value. The use of the target order makes it possible to ensure that no article of the second article type would need to be inserted into the interior of a sequence of articles of the first article type.

In one refinement, each article of the second article type is taken to a previously empty holding apparatus, as a result of which one holding apparatus contains no more than one article of the second article type. In another refinement, two articles of the second article type are taken to at least one holding apparatus, namely two articles of the second article type with the same sorting feature values or with two sorting feature values which are successive in the sorting feature value order. The latter is performed only if there is no third article to be sorted between these two articles of the second article type. In one preferred refinement, each sequence of articles of the first article type is taken to a previously empty holding apparatus.

In one refinement, a holding apparatus which is used has a plurality of bounding elements which enclose a space on a plurality of sides and which are mechanically connected to one another. The holding apparatus is suspended on at least one coupling element which connects said holding apparatus to a guide device, e.g. having two parallel rails. Each article to be sorted is taken to this space, e.g. from the side or from the top. This article is either removed from the holding apparatus by virtue of the article being pulled out of the space sideways or upwards, or the holding apparatus has a flap and the article slides downwards by virtue of gravity when the flap is open.

In another refinement, the holding apparatus has at least one clamp which clamps around at least one article. In one refinement, holding apparatuses having bounding elements for sequences of articles of the first article type are used and holding apparatuses having clamps for articles of the second article type are used.

In one refinement, a central drive advances the holding apparatuses, as a result of which the holding apparatuses do not need to have a separate drive. This saves local drives and a power supply for a holding apparatus. The holding apparatuses are guided along a guide device by means of a transmission means, e.g. are pulled on a chain.

In another refinement, each holding apparatus has a separate local drive which turns a wheel of the holding apparatus, for example.

In a further refinement, the—or at least some—holding apparatuses are designed as static buffer stores and are not moved. In this refinement, both a respective part of each supply and feed device and each sorting output are moved relative to the static holding apparatuses in order to be able to transport the articles to the sorting outputs.

In one refinement, each sorting output comprises a respective receiving element for a container (“tray”). The step in which articles to be sorted are transferred out of a holding apparatus to this sorting output comprises the process in which these articles are taken from the holding apparatus to a container which is situated on this receiving element or is intermittently connected to this receiving element. By way of example, the articles slide out of the holding apparatus into the container. In order to take the filled holding apparatus to a transfer position for the container, the holding apparatus is moved relative to the container, with the holding apparatus or the container or both being moved. A filled container can be replaced by an empty container without touching or using other parts of the sorting installation.

In another refinement, each sorting output is in the form of a static receiving apparatus which is part of the sorting installation or is intermittently connected to the sorting installation. By way of example, the sorting output is a stack compartment into which articles to be sorted are pushed or slide, so that, in the stack compartment, a stack of sorted articles is formed which grows with each further article which is transferred out to this sorting output. By way of example, a container (“cartridge”) which is open on one side is connected to a static receiving apparatus, as a result of which it is possible to push articles into this container and a growing stack of sorted articles is produced in the container.

In a third refinement, each sorting output is a section on a conveying device. A filled holding apparatus is taken to a transfer position for a selected section of the conveying device, and the articles are taken to the section, e.g. by virtue of the articles sliding out of the holding apparatus onto the section.

Combinations of these three refinements are possible.

The sorting feature value of an article is, by way of example, a prescribed destination to which the article needs to be transported or a color, a surface nature or an association between the article and a prescribed class of articles. The sorting feature value may also be a physical property which distinguishes the articles of the first article type from the articles of the second article type. This physical property is a dimension, the volume, the weight or the bending stiffness, for example.

The method according to the solution and the arrangement according to the solution can be used particularly for sorting various stackable articles, e.g. flat mail items, packets and packages, banknotes, check cards, stackable specialist goods, stackable components.

Other features which are considered as characteristic for the invention are set forth in the appended claims.

Although the invention is illustrated and described herein as embodied in a sorting method and sorting configuration for sorting two types of articles to produce a single succession, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a plan view of the standard letter sorting installation, the stack formation device, the data processing installation and the central data memory of the arrangement according to the solution;

FIG. 2 shows a plan view of the large letter sorting installation;

FIG. 3 shows a side view of the large letter sorting installation from FIG. 2;

FIG. 4 shows a side view of a modification of the large letter sorting installation from FIG. 2;

FIG. 5 shows the prescribed delivery sequence and data records for five standard letters and two large letters;

FIG. 6 shows the target order, target sequences and sequences for the seven mail items from FIG. 5;

FIG. 7 shows the synchronization between sorting passes for an average number of standard letters in comparison with the large letters;

FIG. 8 shows the synchronization between sorting passes for a small number of standard letters in comparison with the large letters; and

FIG. 9 shows the synchronization between sorting passes for a large number of standard letters in comparison with the large letters.

### DETAILED DESCRIPTION OF THE INVENTION

In the exemplary embodiment, the invention is used in order to sort flat mail items (letters, postcards, periodicals, catalogs, etc.) of different dimensions. Each mail item is provided with a respective delivery address to which said mail item needs to be transported. In the exemplary embodiment, the mail items act as the articles to be sorted, and the different delivery addresses are the different values of the sorting feature.

A sorting feature value order among the possible delivery addresses of the mail items to be sorted has been prescribed. This sorting feature value order of the possible delivery addresses is prescribed by the delivery sequence of a letter carrier, formerly, the mailman (“carrier/facteur”). The letter carrier visits the delivery addresses in his delivery sequence in this order.

A distinction is drawn between two types of mail items, namely standard letters (“letters”) and large letters (“flats”). The standard letters act as the articles of the first article type, and the large letters act as the articles of the second article type. In the case of a standard letter, each dimension and the weight are within a respective prescribed range. If a dimension or the weight is outside of the respective range, a mail item to be sorted is a large letter. In the exemplary embodiment, particularly small and heavy mail items are also processed as large letters.

Sorting is performed using an arrangement having the following parts:

a standard letter sorting installation (“letter sorting machine”),

a large letter sorting installation (“flats sorting machine”),

a stack formation device (“stacker”),

a data processing installation and

a central data memory.

Both sorting installations are connected to the data processing installation. The data processing installation has read and write access to the central data memory.

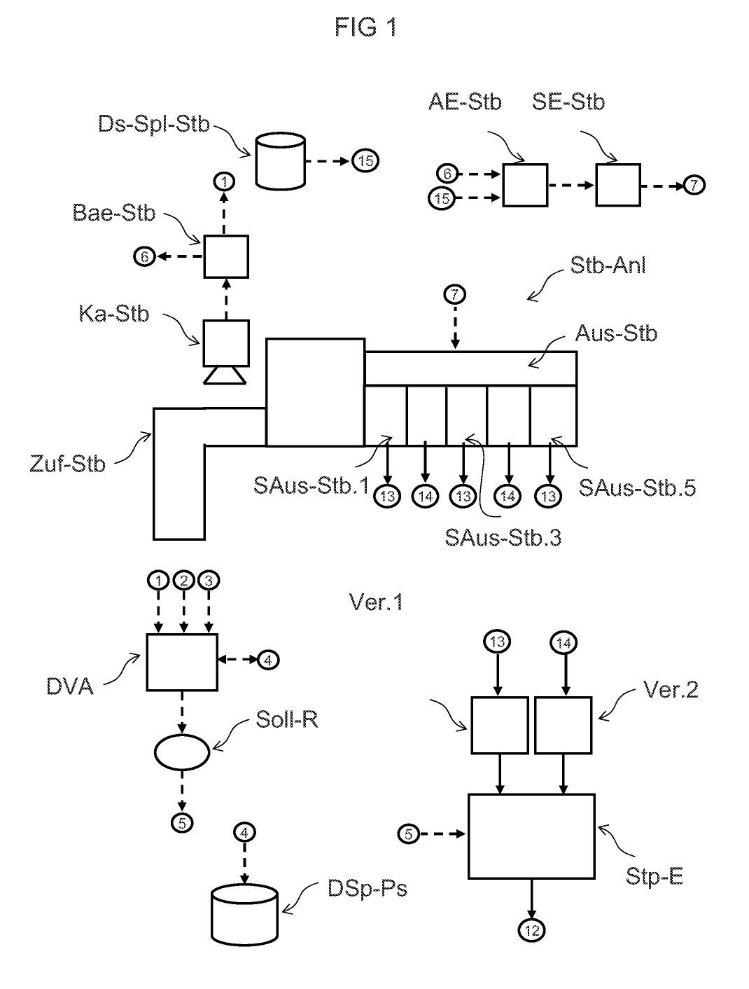

FIG. 1 shows the following parts of the arrangement according to the solution:

the standard letter sorting installation Stb-Anl,

the stack formation device Stp-E,

the data processing installation DVA and

the central data memory DSp-Ps.

The standard letter sorting installation has the following parts:

a standard letter supply device, or feeder, with a singularizer or singulator,

a standard letter measuring device, or gauge,

a standard letter selection unit,

a standard letter outward transfer device and

a multiplicity of standard letter sorting outputs.

FIG. 1 shows the following parts of the standard letter sorting installation Stb-Anl:
the standard letter supply device Zuf-Stb,
the standard letter image acquisition appliance Ka-Stb of the standard letter measuring device,
the standard letter image evaluation unit Bae-Stb of the standard letter measuring device,
a standard letter control unit SE-Stb,
a data memory Ds-Spl-Stb with computer-accessible sorting plans for the standard letter sorting installation Stb-Abl,
the standard letter selection unit AE-Stb,
the standard letter outward transfer device Aus-Stb and
by way of example, five standard letter sorting outputs SAus-Stb.1, . . . , SAus-Stb.5.

In the exemplary embodiment, the stack formation device Stp-E comprises two standard letter singularizers Ver.1, Ver.2 which operate in parallel and are able to singularize standard letters.

Material flows are shown by solid arrows in the figures, and data flows are shown by dashed arrows.

The standard letter selection unit AE-Stb has read access to the data memory Ds-Spl-Stb, which stores computer-accessible sorting plans. The sorting outputs SAus-Stb.1, SAus-Stb.2, . . . of the standard letter sorting installation Stb-Anl are arranged in an order, e.g. in a row or in two rows, one above the other, of output compartments. Each standard letter sorting output is able to take in a respective stack of standard letters.

The read results of the standard letter image evaluation unit Bae-Stb are transmitted to the standard letter selection unit AE-Stb. For each standard letter, the standard letter selection unit AE-Stb selects a respective standard letter sorting output and transmits this selection result to the standard letter control unit SE-Stb. The standard letter control unit SE-Stb actuates the standard letter outward transfer device Aus-Stb such that the standard letter is passed to the selected sorting output SAus-Stb.1, SAus-Stb.2, . . . of the standard letter sorting installation Stb-Anl.

The standard letter sorting installation Stb-Anl is tailored to rapidly sorting standard letters on the basis of a prescribed order among delivery addresses. The parts of the standard letter sorting installation Stb-Anl which are used are tailored to the dimensions and other properties of standard letters.

Preferably, the standard letter sorting installation Stb-Anl transports the standard letters by means of a cover belt system (“pinch-belt system”). Each standard letter is clamped and grasped by two respective opposite continuous conveyor belts at each time during transportation and transported by these continuous conveyor belts.

The large letter sorting installation Gb-Anl has
at least two large letter supply devices (“flat feeders”), each with a large letter singularizer or singulator,
two large letter measuring devices,
a large letter selection unit,
a large letter outward transfer device and
a multiplicity of large letter sorting outputs.

The large letter outward transfer device in the exemplary embodiment comprises
two large letter feed devices,
a holding apparatus arrangement having a multiplicity of holding apparatuses,
a multiplicity of buffer stores and
a holding apparatus transportation device and
a sorting output arrangement having a sorting output transportation device.

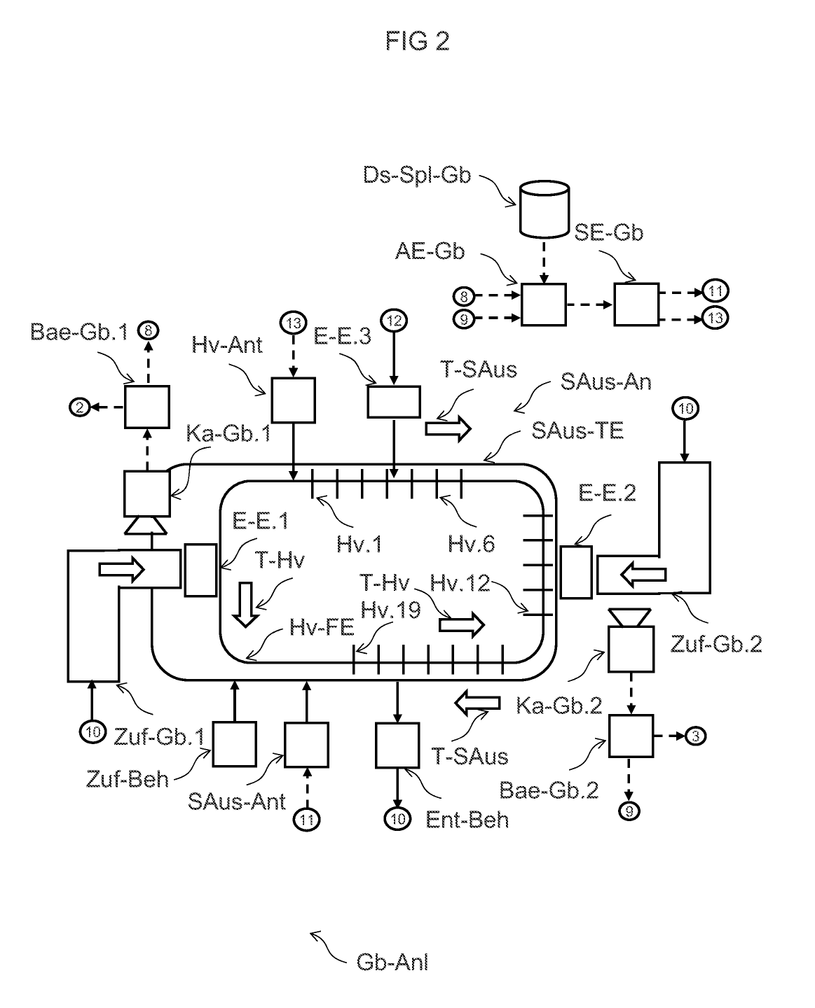

FIG. 2 schematically shows the large letter sorting installation Gb-Anl. This large letter sorting installation Gb-Anl comprises the following parts:
two large letter supply devices Zuf-Gb.1, Zuf-Gb.2,
the large letter image acquisition appliance Ka-Gb.1 and the large letter image evaluation unit Bae-Gb.1 of the first large letter measuring device,
the large letter image acquisition appliance Ka-Gb.2 and the large letter image evaluation unit Bae-Gb.2 of the second large letter measuring device,
a large letter selection unit AE-Gb,
a large letter control unit SE-Gb,
two large letter feed devices E-E.1, E-E.2,
a sequence feed device E-E.3 for feeding sequences of standard letters,
by way of example, 19 holding apparatuses Hv.1, . . . , Hv.19,
the holding apparatus arrangement Hv-An with a holding apparatus drive Hv-Ant, and a holding apparatus guide device Hv-Fe, wherein the holding apparatuses Hv.1, Hv.2, . . . are suspended or mounted in another way on the holding apparatus guide device Hv-FE, and the holding apparatus drive Hv-Ant moves the holding apparatus guide device Hv-FE together with the holding apparatuses Hv.1, Hv.2, . . . ,
the sorting output arrangement SAus-An with the sorting output transportation device SAus-TE and a sorting output drive SAus-Ant,
a supply device Zuf-Beh for empty large letter containers, and
a removal device Ent-Beh for filled large letter containers.

The figure indicates the transportation direction T-SAus in which the sorting output transportation device SAus-TE is moved and the transportation direction T-Hv of the holding apparatus guide device Hv-FE.

Preferably, the holding apparatus conveying device Hv-FE describes a closed conveying path on which the holding apparatuses Hv.1, Hv.2, . . . are always transported in the same transportation direction T-Hv. This conveying path preferably comprises a plurality of straight sections. The three feed devices E-E.1, E-E.2, E-E.3 are all arranged on this one section. As a result, the remainder of the conveying path remains free of feed devices and is therefore more accessible from the outside, e.g. for maintenance work.

Each holding apparatus Hv.1, Hv.2, . . . is able to take in a large letter or a plurality of standard letters, respectively. Each large letter supply device Zuf-Gb.1, Zuf-Gb.2 is connected to a respective large letter feed device E-E.1, E-E.2. Each feed device E-E.1, E-E.2 is able to take a large letter or a plurality of standard letters, respectively, to a holding apparatus. Preferably, each large letter is likewise transported by a cover belt system on its path from a large letter supply device Zuf-Gb.1, Zuf-Gb.2 to a large letter feed device E-E.1, E-E.2.

In the exemplary embodiment, each holding apparatus Hv.1, Hv.2, . . . is in the form of a storage pocket having two lateral faces, the storage pocket having an opening at the top or on one side. Mail items are taken to this holding apparatus in an upright position from the top or from the side. The mail items are then situated in the space between the two lateral faces of the holding apparatus. The holding apparatus has at least one holding element in the form of a clamp which runs in a rail of the holding apparatus guide device HV-FE. In one form, the single clamp is fitted centrally. In another embodiment, two clamps are fitted at the sides on the two lateral faces of a holding apparatus. These two clamps run in two rails.

The driven holding apparatus guide device Hv-FE is able to move the holding apparatuses along a closed conveying path. In order to effect this, the driven holding apparatus guide device Hv-FE is designed to move the holding apparatuses Hv.1, Hv.2, . . . along this closed conveying path of the holding arrangement Hv-An. Preferably, the holding apparatuses are transported at a largely constant speed and always in the same transportation direction T-Hv along this conveying path.

In one refinement, holding apparatuses of the same type are used. These holding apparatuses of the same type take in either a large letter or a stack of standard letters. In another refinement, two different types of holding apparatuses are used, e.g. one type for a respective large letter and one type for a stack of standard letters. The different types of holding apparatuses are situated on the closed conveying path in a mixed succession. If the refinement with two lateral clamps as holding elements is used, these clamps are preferably always at the same distance, regardless of the type of the holding apparatus. The different types of holding apparatuses differ in their heights, for example, and also, in one refinement, in their thicknesses.

It is possible for the holding apparatuses Hv.1, Hv.2, . . . to be split over two or still more holding arrangements, each holding arrangement respectively comprising a closed conveying path and the holding apparatuses of this holding arrangement taking this one closed conveying path and not reaching the other closed conveying paths.

The holding arrangement or the holding arrangements are in one plane. The multiplicity of buffer stores are in a further plane which is arranged beneath the plane of the holding arrangements. Each buffer store is able to take in at least one large letter or a plurality of standard letters. The buffer store has a flap or another suitable opening mechanism in order to output its content downwards. In one refinement, the buffer stores are arranged statically.

The transportation device is designed to take a holding apparatus with at least one mail item to a transfer position for a previously selected buffer store by moving the holding apparatus along the conveying path and allowing the mail item to slide out of the holding apparatus into the selected buffer store.

Beneath the preferably statically arranged buffer stores are the large letter sorting outputs. In the exemplary embodiment, the large letter sorting installation has a sorting output transportation device.

In one preferred refinement, the sorting output transportation device has a succession of support areas, e.g. of trays or driveless trollies. These support areas are connected to a chain and are transported on a guide device, e.g. on rails or along rails. A sorting output drive pulls the chain and thereby moves the support areas along the guide device. In one refinement, each support area forms a respective large letter sorting output. In another refinement, at least one container for large letters can be placed on each support area. Each container on a support area acts as a large letter sorting output. It is possible for two or still more containers to be placed on a support area and therefore for this support area to comprise two large letter sorting outputs.

In another refinement, the sorting output transportation device has a plurality of driven conveyor belts. These conveyor belts together form a closed conveying path. The conveying path comprises a plurality of sections. Each section forms a respective large letter sorting output.

In one refinement, a mail item is transferred out to a previously selected sorting output by virtue of each section forming a separate large letter sorting output and the mail item being taken to this selected section. As a result, a respective stack of mail items is produced on each section. In another refinement, a respective initially empty container is first of all placed onto each section used. This container acts as a large letter sorting output and is able to take in a plurality of large letters and a plurality of standard letters. The mail items for a previously selected large letter sorting output are taken to this container, as a result of which a stack of mail items is produced in the container.

In both refinements, all mail items slide out of a buffer store downwards onto the previously selected section, specifically either directly onto a conveyor belt of the sorting output transportation device or onto a section or into a container. The aforementioned transportation device moves the selected section to a transfer position for this buffer store.

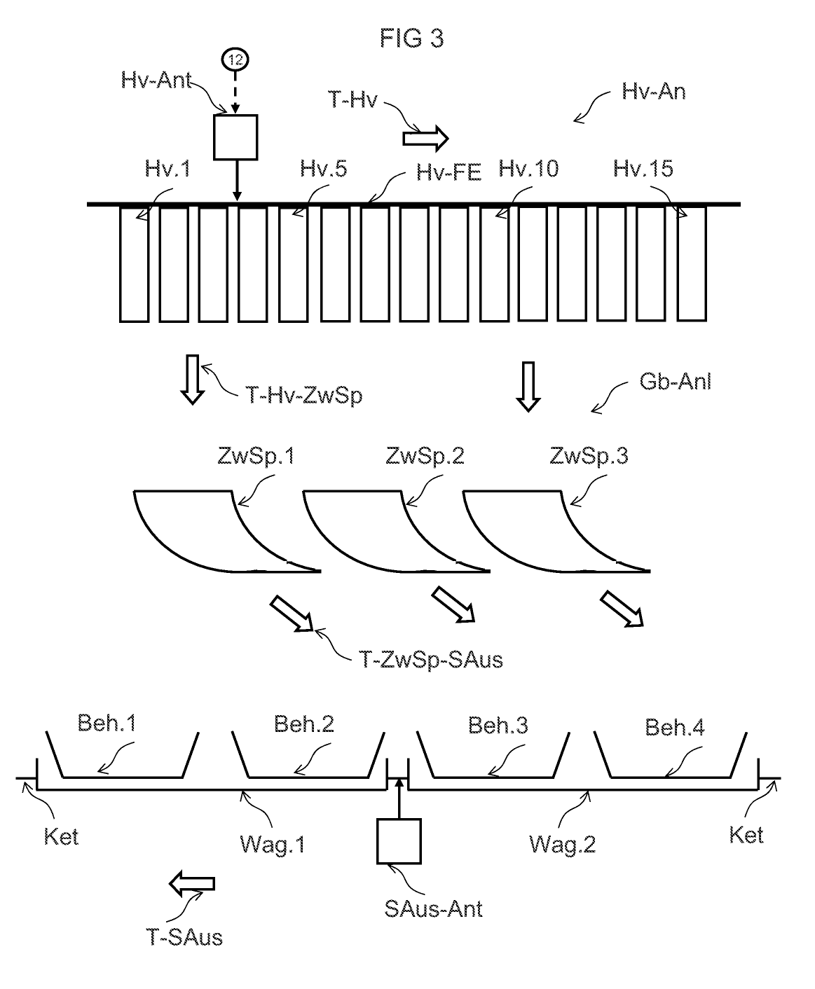

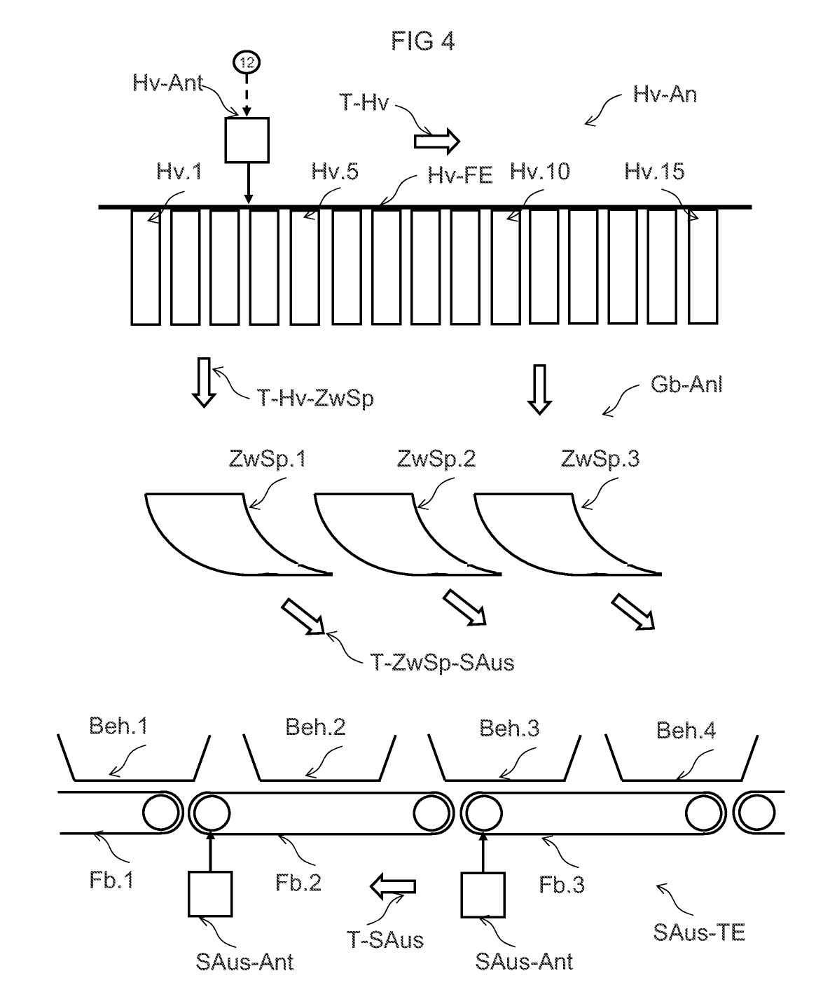

FIG. 3 and FIG. 4 show a side view of two embodiments of the large letter outward transfer device and also show the planes situated above one another. They show:
by way of example, 15 holding apparatuses Hv.1, . . . , Hv.15 on the holding apparatus guide device Hv-FE,
the transportation direction T-Hv in which the holding apparatus guide device Hv-FE is moved and for its part moves the holding apparatuses Hv.1, Hv.2, . . . ,
three static buffer stores ZwSp.1, ZwSp.2, ZwSp.3,
the direction T-Hv-ZwSp, in which mail items slide out of the holding apparatuses Hv.1, Hv.2, . . . approximately perpendicularly downwards into the buffer stores ZwSp.1, ZwSp.2, . . . ,
four containers Beh.1, Beh.2, Beh.3, Beh.4 which act as four large letter sorting outputs,
the transportation direction T-SAus in which the containers Beh.1, Beh.2, Beh.3 are transported, and
the direction T-ZwSp-Beh in which mail items slide out of the buffer stores ZwSp.1, ZwSp.2, ZwSp.3 obliquely downwards into the containers Beh.1, Beh.2, Beh.3, Beh.4.

FIG. 3 shows the preferred refinement with the driven trolleys or trays. The two large letter containers Beh.1, Beh.2 stand on a trolley or a tray Wag.1. The two large letter containers Beh.3 and Beh.4 stand on a further trolley Wag.2. The trolleys or trays Wag.1, Wag.2 are connected to one another by means of a chain Ket. The drive SAus-Ant moves this chain Ket. The trolleys or trays Wag.1, Wag.2 slide in rails—not shown—or on or along another suitable guide device in the transportation direction T-SAus.

It is also possible not to use a container at all and for each trolley Wag.1, Wag.2, . . . to be used directly as a sorting output for the large letter sorting installation Gb-Anl. The mail items slide directly out of the buffer stores onto a trolley. Each trolley Wag.1, Wag.2 is thus a single separate sorting output.

FIG. 4 shows another refinement with containers and with three continuous conveyor belts Fb.1, Fb.2, Fb.3. The containers Beh.1, Beh.2, . . . stand on these continuous conveyor belts and on further continuous conveyor belts. The drive SAus-Ant drives a respective roller of each conveyor belt Fb.1, Fb.2, Fb.3.

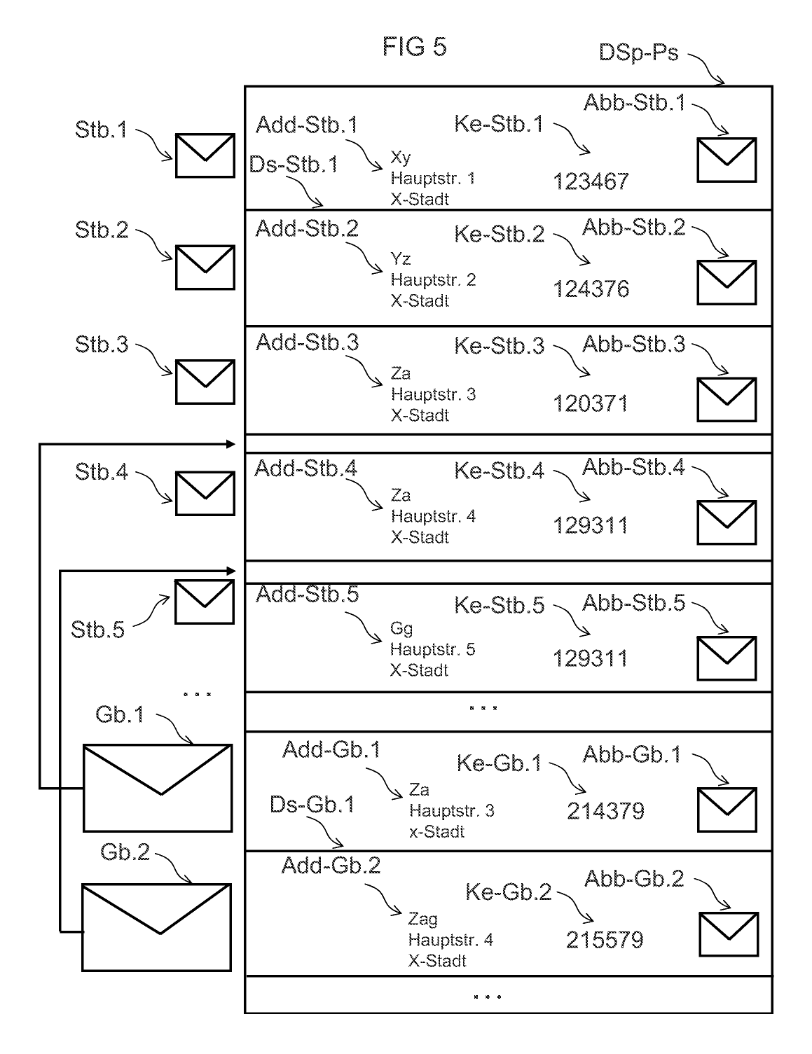

FIG. 5 shows, by way of example, five standard letters Stb.1, . . . . Stb.5 and two large letters Gb.1, Gb.2. The five standard letters Stb.1, . . . , Stb.5 need to be transported to the five delivery addresses Add-Stb.1, . . . , Add-Stb.5, and the two large letters Gb.1, Gb.2 need to be transported to the two delivery addresses Add.Gb.1 and Add-GB.2. All seven delivery addresses are in the main street of a fictitious “X Town”. The prescribed order among the delivery addresses comprises the component order Hauptstr. 1, Hauptstr. 2, . . . , Hauptstr. 5.

As already explained, an order is prescribed among the delivery addresses. In one possible refinement, the mail items to be sorted have not passed through a sorting installation previously. The arrangement according to the solution therefore sorts the main items without prior knowledge of the delivery addresses. The possible delivery addresses used are therefore all valid delivery addresses in a delivery area, even if there is no mail item to be transported to this delivery address on this day. Each sorting plan used in the first sorting pass accordingly contains all possible delivery addresses.

In one preferred refinement, all mail items to be sorted have already each passed through a sorting installation previously, however. By way of example, the arrangement according to the solution is used for what is known as incoming and delivery-sequence sorting, and different sorting installations have previously each performed outgoing sorting for the mail items which now need to be sorted. A logistical network with outgoing sorting and incoming sorting is described in EP 724490 B1, for example. On the basis of this preceding sorting, it is known for each delivery address how many mail items to be sorted need to be transported to this delivery address in each case and therefore need to be sorted by the arrangement according to the solution. In particular, it is known which delivery addresses actually arise and which do not. The sorting feature value order used is an order among the actually occurring delivery addresses.

Preferably, the data records for mail items are already produced in the preceding sorting operations and created in the central data memory DSp-Ps. The data records of those mail items which actually need to be transported to the arrangement according to the solution are used for the arrangement according to the solution. The target order among internal identifiers of mail items, which is described further below, is preferably actually produced when
the preceding sorting operations are complete,
the data records for the mail items to be processed have been created and
it is certain which mail items need to be transported to the arrangement according to the solution with which internal identifiers and which delivery addresses and need to be sorted exactly into delivery sequence by said arrangement according to the solution.

In the exemplary embodiment, the standard letter sorting installation Stb-Anl performs at least two sorting passes.

In the first sorting pass, the standard letters are supplied to the standard letter supply device Zuf-Stb. The standard letter supply device Zuf-Stb singularizes the supplied standard letters. This produces a stream of standard letters at a distance from one another which pass through the standard letter sorting installation Stb-Anl and are distributed over the standard letter sorting outputs Stb-SAus.1, Stb-SAus.2, . . . of the standard letter sorting installation Stb-Anl. Preferably, the standard letters are transported upright.

The standard letter sorting installation Stb-Anl performs the following steps for each passing standard letter during the first sorting pass:
The image capture appliance Ka-Stb of the standard letter measuring device produces a computer-accessible depiction of that surface of the standard letter which shows the delivery address.
The image evaluation unit (“OCR unit”) Bae-Stb of the standard letter measuring device evaluates this depiction and deciphers the delivery address of the standard letter.
The standard letter selection unit AE-Stb evaluates the sorting plan for the first sorting pass, which is stored in the data memory Ds-Spl-Stb. On the basis of this sorting plan and the respectively deciphered delivery address, the selection unit AE-Stb selects a standard letter sorting output SAus-Stb.1, SAus-Stb.2, . . . for the standard letter.
The standard letter outward transfer device Aus-Stb transports the standard letter to the selected standard letter sorting output SAus-Stb.1, SAus-Stb.2, . . . and transfers the standard letter out to this standard letter sorting output.

As a result, a respective stack of standard letters is produced in each standard letter sorting output used SAus-Stb.1, SAus-Stb.2, . . . in the standard letter sorting installation Stb-Anl.

The data processing installation DVA creates a respective data record for each mail item in the central data memory DSp-Ps. Therefore, a respective data record is created for each standard letter and also for each large letter. This data record comprises
an internal identifier for the mail item, which distinguishes said mail item from all other mail items which pass through the arrangement within a certain period, and
a tag for the deciphered delivery address of the mail item.

The data processing installation DVA allocates the internal identifiers for both types of mail items. This prevents an internal identifier from being unintentionally allocated twice. The delivery address tag is produced by the respective measuring device on the basis of the read result.

FIG. 5 shows, by way of example, seven data records for the five standard letters Stb.1, . . . , Stb.5 and for the two large letters Gb.1, Gb.2 in the central data memory DSp-Ps. These data records additionally contain the respective computer-accessible depiction of the mail item, which shows the delivery address. The exemplary data record Ds-Stb.1 for the standard letter Stb.1 comprises the deciphered delivery address Add-Stb.1, the internal identifier Ke-Stb.1 and the computer-accessible depiction Abb-Stb.1. Accordingly, the exemplary data record Ds-Gb.1 for the large letter Gb.1 comprises the deciphered delivery address Add-Gb.1, the internal identifier Ke-Gb.1 and the computer-accessible depiction Abb-Gb.1.

Following the first sorting pass, the standard letters have been distributed over the standard letter sorting outputs SAus-Stb.1, SAus-Stb.2, . . . of the standard letter sorting installation Stb-Anl. An emptying and supply order among these standard letter sorting outputs SAus-Stb.1, SAus-Stb.2, . . . has been prescribed. The standard letter sorting outputs SAus-Stb.1, SAus-Stb.2, . . . are empty on the basis of this emptying and supply order. All standard letters from a respective standard letter sorting output are supplied to the standard letter supply device Zuf-Stb again. The standard letter supply device Zuf-Stb singularizes the supplied standard letters, and the standard letters pass through the standard letter sorting installation Stb-Anl again at a distance from one another in the second sorting pass.

The already deciphered destination address of each standard letter is ascertained in the second sorting pass. In one refinement, a coding for the respective deciphered destination address is printed on the standard letter in the first sorting pass. This coding is in the form of a bar pattern (“bar code”), for example, and is read in the second sorting pass.

In another refinement, a respective feature value vector with values for optically capturable features is produced in each sorting pass, and the mail item is identified from this feature value vector in the second sorting pass. Such methods have become known by the name “fingerprint” or else “virtual ID” and are described in German published patent applications Nos. DE 10 2008 017 190 A1, DE 10 2008 017 189 A1 and DE 10 2008 017 187 A1, for example.

The standard letter selection unit AE-Stb applies a sorting plan for the second sorting pass, which differs from the sorting plan for the first sorting pass and is likewise stored in the data memory Ds-Spl-Stb. On the basis of the ascertained delivery address and the sorting plan for the second sorting pass, the standard letter selection unit AE-Stb selects a sorting output for the standard letter. In the second sorting pass too, the standard letter outward transfer device Aus-Stb transfers the standard letter out to the respective selected standard letter sorting output. In the exemplary embodiment, the same standard letter sorting outputs Stb-SAus.1, Stb-SAus.2, . . . are used for the second sorting pass as in the first sorting pass. It is also possible for the standard letter sorting installation Stb-Anl to use different sorting outputs in the second sorting pass than in the first sorting pass.

Following the second sorting pass, a succession of sorted standard letters has been produced in each standard letter sorting output used Ses-Stb.1, Ses-Stb.2, . . . . Usually, a respective standard letter sorting output SAus-Stb.1, SAus-Stb.2, . . . contains standard letters for a plurality of delivery addresses. The reason for this is that there are significantly more possible and also significantly more actually used different delivery addresses than standard letter sorting outputs SAus-Stb.1, SAus-Stb.2, . . . .

The large letter sorting installation Gb-Anl first of all performs a first sorting pass, in which the large letters are distributed over large letter sorting outputs.

In the exemplary embodiment, two large letter supply devices Zuf-Gb.1, Zuf-Gb.2 are used which are tailored to the processing of large letters. Preferably, both large letter supply devices Zuf-Gb.1, Zuf-Gb.2 are used in parallel in the first sorting pass. Since both large letter supply devices Zuf-Gb.1, Zuf-Gb.2 operate in parallel, time is saved in comparison with a mode of operation in which only one large letter supply device is used. The large letters are split into two sets. The first set is transported to the first large letter supply device Zuf-Gb.1 and is supplied to the large letter sorting installation Gb-Anl by said large letter supply device. The second set is transported to the second large letter supply device Zuf-Gb.2 and is supplied by the latter.

In the exemplary embodiment, the sequence feed device E-E.3 is not used in the first sorting pass of the large letter sorting installation Gb-Anl. The first large letter supply device Zuf-Gb.1 is not used at all in the first sorting pass in this refinement and is used in the second sorting pass to supply the sequences containing standard letters to the large letter sorting installation Gb-Anl. This refinement allows the sequence feed device E-E.3 to be tailored to the supply of sequences for standard letters and allows the two large letter supply devices Zuf-Gb.1, Zuf-Gb.2 to be tailored to the supply of individual large letters. This increases the throughput in comparison with an all-purpose supply device which is suitable for both types of mail items.

Each large letter supply device Zuf-Gb.1, Zuf-Gb.2 singularizes the supplied large letters and produces a stream of large letters at a distance from one another which pass through the large letter sorting installation Gb-Anl.

In the first sorting pass, the large letter sorting installation Gb-Anl performs the following steps for each large letter:
A large letter image acquisition appliance Ka-Gb.1, Ka-Gb.2 of a large letter measuring device produces a computer-accessible depiction of that surface of the large letter which shows the delivery address.
A large letter image evaluation unit Ka-Gb.1, Bae-Gb.2 of a large letter measuring device deciphers the delivery address of the large letter, for which purpose the image evaluation unit Bae-Gb.2 evaluates the computer-accessible depiction.
The large letter selection unit AE-Gb selects a large letter sorting output for this large letter. For this, the large letter selection unit AE-Gb applies a computer-accessible sorting plan. This sorting plan is stored in the data memory DSp-Spl-Gb.
The large letter is transported from a large letter supply device Zuf-Gb.1, Zuf-Gb.2 to a feed device E-E.1, E-E.2.
This feed device E-E.1, E-E.2 takes the large letter to a previously empty holding apparatus.
The holding apparatus with the large letter is transported in the transportation direction T-HV and thereby taken to a transfer position for a buffer store.

The large letter slides out of the holding apparatus into the buffer store.

The selected large letter sorting output, that is to say a section of the sorting output arrangement SAus-An, is transported in the transportation direction T-SAus and thereby taken to a transfer position for said buffer store by virtue of the section being taken to a position perpendicularly or obliquely beneath the buffer store.

The large letter slides out of the buffer store Zw-Sp.1, Zw-Sp.2, . . . into the selected large letter sorting output, that is to say onto a section of the sorting output arrangement SAus-An and, by way of example, into a large letter container. The buffer store in the exemplary embodiment has oblique lateral walls. The effect achieved by this is that a mail item slides obliquely out of the buffer store Zw-Sp.1, Zw-Sp.2, . . . into the large letter sorting output, e.g. into the selected container.

Both the standard letters and the large letters are sorted in at least two sorting passes, e.g. on the basis of the sorting method “radix sort” or “tree sort”. The standard letter sorting installation Stb-Anl sorts the standard letters as described above in two sorting passes. The large letter sorting installation Gb-Anl first of all performs a first sorting pass only with large letters. In a second sorting pass, the large letter sorting installation Gb-Anl sorts the large letters and the standard letters together and exactly into delivery sequence, as described below.

The text below first of all explains a sorting method which is used. Both sorting installations Stb-Anl, Gb-Anl in the exemplary embodiment sort on the basis of the sorting method “radix sort” in at least two sorting passes. The “radix sort” method is outlined generally first of all.

M is taken to be the number of different delivery addresses for which the mail items are sorted, with a sorting feature value order having been prescribed among these M delivery addresses. In the first sorting pass, M1 sorting outputs are used, and in the second sorting pass, M2 sorting outputs are used, and also overflow compartments. The following applies: M1×M2≧M. M1=M2 is possible. The sorting outputs used are arranged in an order. Each delivery address is described by a tuple (i1, i2), where 1≦i1≦M2 and 1≦i2≦M1. The tuples are prescribed such that the delivery address (i1, i2) has the position number (i1−1)×M2+i2 in the sorting feature value order. If the M1×M2 tuples are thus arranged in the sorting feature value order, the order (1, 1), (1, 2), . . . , (1, M2), (2, 1), (2, 2), . . . , (M1, M2) is produced. The first number i1 in the tuple (i1, i2) is also called the “high bin”, and the second number i2 is called the “low bin”.

In the first sorting pass, a sorting plan is applied which allocates each tuple (i1, i2) the sorting output i2 (1≦i1≦M2, 1≦i2≦M1). In the first sorting pass, all mail items with the delivery addresses (1, 1), (2, 1), . . . (M2, 1) are thus transferred out to the first sorting output, all mail items with the delivery addresses (2, 1), (2, 2), . . . (M2, 2) are transferred out to the second sorting output, and so on.

For the second sorting pass, the mail items are supplied to the sorting installation again such that first of all the mail items from the first sorting output are supplied to the sorting installation again, then the mail items from the second sorting output, and so on.

In the second sorting pass, a sorting plan is applied which allocates each tuple (i1, i2) the sorting output i1. In the second sorting pass, all mail items with the delivery addresses (1, 1), (1, 2), . . . , (1, M1) are thus transferred out to the first sorting output, and so on. Following the conclusion of the second sorting pass, the sorting output No. i1 contains all mail items with the order (i1, 1), (i1, 2), . . . (i1, M1), the mail items with the delivery address (i1, 1) being transferred out to the sorting output No. i1 first and those with the delivery address (i1, M1) being transferred out last.

As already explained, the data processing installation DVA produces, for each mail item, a respective data record with an internal identifier for this mail item and also a tag for the deciphered delivery address of this mail item.

A sorting feature value order is prescribed among the possible or preferably among the actually used delivery addresses of mail items, which, in the exemplary embodiment, act as the possible sorting feature values. The data processing installation DVA then produces a target order among internal identifiers.

This target order Soll-R is represented by a suitable data structure. By way of example, each data record is allocated a position number in said target order. This one target order Soll-R comprises all internal identifiers of the standard letters and the large letters.

The data processing installation DVA produces this target order Soll-R with the internal identifiers after the standard letter sorting installation Stb-Anl has concluded the first sorting pass with the standard letters to be sorted and the large letter sorting installation Gb-Anl has concluded the first sorting pass with the large letters to be sorted. The earliest possible time for producing the target order Soll-R is the time at which the respective delivery address of each standard letter and of each large letter has been deciphered and has been transmitted to the data processing installation DVA.

Usually, a plurality of mail items need to be transported to the same delivery address—more generally: a plurality of articles have the same sorting feature value. The order of occurrence of the internal identifiers of standard letters in this order Soll-R is unimportant.

In one refinement, the internal identifiers of large letters are arranged in the target order Soll-R such that they are followed first or last of all by the internal identifiers for the large letters to a delivery address and then or before then by the internal identifiers for the standard letters to this delivery address. There is thus no opportunity provided for first of all the internal identifier of a standard letter to a delivery address, then the internal identifier of a large letter to this delivery address and then again the internal identifier of a standard letter to this delivery address to occur in the same target order. This refinement results in target sequences which are as long as possible, i.e. in target sequences with as many internal identifiers as possible. This later prompts each holding apparatus Hv.1, Hv.2, . . . to be utilized as well as possible, that is to say as many standard letters as possible are taken to a holding apparatus.

The data processing installation DVA selects a plurality of target sequences of internal identifiers of standard letters from this target order Soll-R. Each target sequence has the following properties:
The target sequence exclusively comprises internal identifiers Ke-Stb.1, Ke-Stb.2, . . . of standard letters Stb.1, Stb.2, . . . , that is to say does not have an internal identifier of a large letter.
The target sequence is a section of the target order Soll-R among all internal identifiers.
The target sequence is firstly as long as possible, i.e. comprises as many internal identifiers as possible. Secondly, each target sequence is short enough for all standard letters whose internal identifiers make up this target sequence to fit into the same holding apparatus Hv.1, Hv.2, . . . and into the same buffer store Zw-Sp.1, Zw-sp.2., . . . .

By way of example, a maximum number of elements of a target sequence is prescribed. Alternatively, the respective thickness of each standard letter is measured before the target sequences are produced, and the thicknesses are added until a maximum thickness has been reached.

It is possible for a target sequence to contain internal identifiers Ke-Stb.1, Ke-Stb.2 of standard letters Stb.1, Stb.2 which need to be sent to different delivery addresses and which follow one another directly in the sorting feature value order. Therefore, a reference delivery address is stipulated for each target sequence, e.g. as the first or last delivery address for those standard letters whose internal identifier makes up the target sequence.

The target sequences are furthermore produced such that the internal identifier Ke-Stb.x of each standard letter Stb.x belongs to exactly one target sequence. As already explained, no internal identifiers of large letters belong to the target sequences.

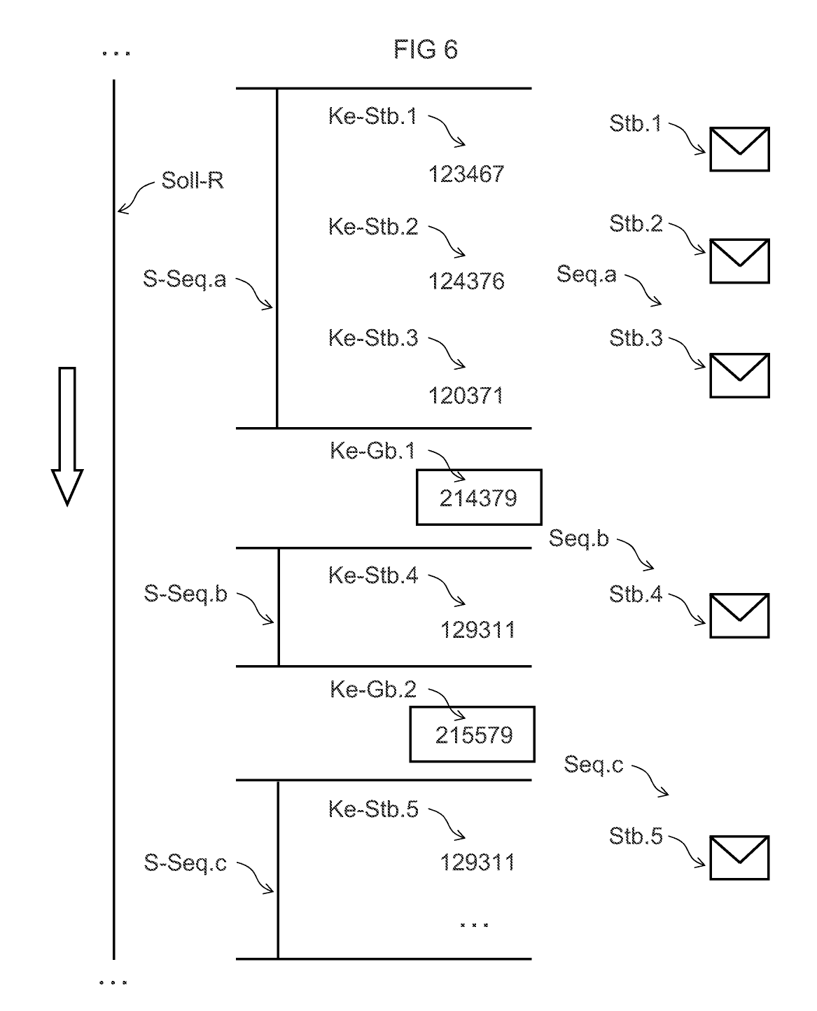

FIG. 6 uses the example from FIG. 5 to illustrate how the target order Soll-R and the target sequences are produced among internal identifiers of the mail items to be sorted. The target order Soll-R among internal identifiers in this example comprises the succession Ke-Stb.1, Ke-Stb.2, Ke-Stb.3, Ke-Gb.1, Ke-Stb.4, Ke-Gb.2 and Ke-Stb.5. The positions of internal identifiers of large letters are shown in a form highlighted by rectangles in FIG. 6.

In the example from FIG. 6, three target sequences S-Seq.a, S.Seq.b, S-Seq.c are formed. The target sequence S-Seq.a comprises the three internal identifiers Ke-Stb.1, Ke-Stb.2 and Ke-Stb.3. The target sequence S-Seq.b comprises the identifier Ke-Stb.4 as the single internal identifier. The target sequence S-Seq.c comprises the internal identifier K-Stb.5 and further internal identifiers, which are not shown in FIG. 6. The reference delivery address of the target sequence S-Seq.a is “Hauptstr. 1”, the reference delivery address of the target sequence S-Seq.b is “Hauptstr. 4” and the reference delivery address of the target sequence S-Seq.c is “Hauptstr.5”. The stack formation device Stp-E produces the sequence Seq.a with the standard letters Stb.1, Stb.2 and Stb.3, the sequence Seq.b with the standard letter Stb.4 and the sequence Seq.c with the standard letter Stb.4 and with further standard letters. The target sequences Seq.a, Seq.b, . . . calculated in this manner are transmitted to the standard letter sorting installation Stb-Anl and to the stack formation device Stp-E.

There now follows an explanation of what result the standard letter sorting installation Stb-Anl has attained after the two sorting passes. In each standard letter sorting output SAus-Stb.1, SAus-Stb.2, . . . of the standard letter sorting installation Stb-Anl, a plurality of sequences (also small stack) of standard letters have been produced in each case after the last sorting pass. Each sequence in a standard letter sorting output corresponds to exactly one target sequence in the target order. This means that the standard letter sorting installation Stb-Anl forms each sequence such that
the internal identifiers of the mail items in the sequence are exactly the internal identifiers of the target sequences and
the order of the standard letters in the sequence is exactly the order of the associated identifiers in the target sequence.

The standard letters in a sequence have thus been sorted on the basis of the target order Soll-R and therefore the prescribed sorting feature value order after the second sorting pass. In order to attain this result, the standard sorting installation Stb-Anl performs two sorting passes.

The sequence with standard letters has been distributed over the sorting outputs as follows after the second sorting pass: if a sequence of standard letters is replaced mentally by a single reference standard letter which needs to be transported to the reference delivery address, these reference standard letters have been distributed over the standard letter sorting outputs after the first sorting pass of a “radix sort”. If M1 standard letter sorting outputs are thus used in both sorting passes, the sequence with the reference delivery address (i1, i2) arrives in the sorting output number i2 (1≦i1≦M1, 1≦i2≦M1) after the second sorting pass.

The large letter sorting installation Gb-Anl likewise uses “radix sort” in both sorting passes. Thus, if M1 large letter sorting outputs are used, the large letter with the delivery address (i1, i2) arrives in the large letter sorting output number i2 in the first sorting pass.

The stack formation device Stp-E produces a respective sequence of sorted standard letters for each transmitted target sequence of internal identifiers.

In one refinement, the sequences of standard letters are removed directly from the standard letter sorting outputs Stb-SAus.1, Stb-SAus.2, . . . and taken to the sequence feed device E-E.3. Each sequence is supplied to the sequence feed device E-E.3 individually.

In one preferred refinement, which is also shown in the figures, the sorted standard letters are, by contrast, transported from a standard letter sorting output Stb-SAus.1, Stb-SAus.2, . . . in stacks to a standard letter singularizer Ver.1, Ver.2 of the stack formation device Stp-E, for example all standard letters from a standard letter sorting output at once and in one container or in another suitable means of transport. The order among the standard letters from a standard letter sorting output Stb-SAus.1, Stb-SAus.2, . . . is not altered. A prescribed supply order among the standard letter sorting outputs of the standard letter sorting installation Stb-Anl is observed.

Preferably, all standard letters from the first standard letter sorting output Stb-SAus.1, the third standard letter sorting output Stb-SAus.3, the fifth standard letter sorting output Stb-SAus.5 and so on are transported to the first standard letter singularizer Ver.1 of the stack formation device Stp-E. All standard letters from the second standard letter sorting output Stb-SAus.2, the fourth standard letter sorting output Stb-SAus.4, the sixth standard letter sorting output Stb-SAus.6 and so on are transported to the second standard letter singularizer Ver.2.

In one refinement, the target sequences Seq.a, Seq.b, . . . are transmitted to the standard letter sorting installation. In a second sorting pass, the standard letter sorting installation Stb-Anl transfers separating elements out to the standard letter sorting outputs, as a result of which two successive sequences of standard letters are separated by a separating element. This separating element is located together with the standard letters in a standard letter sorting output. Each separating element differs from the standard letters in terms of dimension and/or appearance.

The separating elements are supplied together with the standard letters to the standard letter singularizers Ver.1, Ver.2. The standard letter singularizers Ver.1, Ver.2 of the stack formation device Stp-E recognize from the separating elements where a sequence ends and a subsequent sequence starts in a supplied succession of mail items. The stack formation device Stp-E gathers in the separating elements and outputs them separately from the sequences. The separating elements are not required for the second sorting pass on the large letter sorting installation Gb-Anl.

In another refinement, no separating elements are used. On the contrary, the target order Soll-R and the target sequences Seq.a, Seq.b are transmitted to the stack formation device Stp-E. The stack formation device Stp-E processes this information in order to produce the sequences again from the supplied standard letters.

In one refinement, the stack formation device Stp-E has a measuring device for delivery addresses and ascertains the actual delivery address for each supplied standard letter. The transmitted target sequences Seq.a, Seq.b comprise the ascertained delivery addresses. The measuring device checks whether or not the actual delivery address of a supplied standard letter matches the delivery address of that standard letter which should occur on the basis of the currently processed target sequence. This allows unwanted alterations in the order of the supplied standard letters to be recognized and corrected.

In the exemplary embodiment, the two standard letter singularizers Ver.1, Ver.2 of the stack formation device Stp-E singularize the supplied standard letters. Two streams of standard letters at a distance from one another pass through the stack formation device Stp-E. The stack formation device Stp-E pushes together the respective standard letters in a sequence, as a result of which the standard letters in this sequence overlap to some extent and a distance appears between the two different sequences. Such stack formation devices are described or mentioned in European patent application publications and patents EP 2065325 A1, EP 1334937 B1, EP 923997 A2, EP 654309 A2 and in U.S. Pat. No. 6,435,331 B1, for example.

A stream of sequences at a distance from one another leaves the stack formation device Stp-E. First of all, all those sequences whose respective reference delivery address has the form (i1, 1), where 1≦i1≦M1 and M1 is the number of standard letter sorting outputs used, in the “radix sort” leave the stack formation device Stp-E. Next, all those sequences whose respective reference delivery address has the form (i1, i2), then that with (i1, 3) and so on, leave the stack formation device Stp-E.

Each sequence of standard letters is transported as a stack of standard letters to the sequence production device E-E.3. The standard letters in a sequence overlap at least to some extent during transportation. Preferably, two successive sequences reach the sequence production device E-E.3 at a sufficiently great distance. This distance is large enough for the sequence production device E-E.3 first of all to be able to take the first sequence to a holding apparatus Hv.1, Hv.2, . . . , for this holding apparatus to be transported onward and then for the sequence production device E-E.3 to be able to take the second sequence to another holding apparatus. It is not necessary for the standard letters in a sequence to be bound together, i.e. by a band or a plastic cover. The sequences are supplied to the large letter sorting installation Gb-Anl by the sequence production device E-E.3. The sequence production device E-E.3 feeds each sequence into a previously free holding apparatus Hv.1, Hv.2, . . . in the large letter sorting installation Gb-Anl. For each sequence, a new holding apparatus is used.

As explained above, the large letters have been distributed over the large letter sorting outputs in the first sorting pass, e.g. by distributing the large letters into containers Beh.1, Beh.2 on the sorting output arrangement SAus-An. These containers Beh.1, Beh.2, . . . are removed from the sorting output transportation device SAus-TE by means of the unloading device Ent-Beh and are transported to the first large letter supply device Zuf-Gb.1 in succession.

The large letters are supplied to the large letter sorting installation Gb-Anl by the first large letter supply device Zuf-Gb.1 and are transported to the first feed device. The first feed device E-E.1 transfers the large letters into a respectively previously free holding apparatus. For each large letter, a new holding apparatus Hv.1, Hv.2, . . . is used. In the exemplary embodiment, the first large letter supply device Zuf-Gb.1, the first large letter feed device E-E.1 and the sequence production device E-E.3 operate at parallel times or at least at overlapping times. If the holding apparatus arrangement Hv-An is able to be filled by three feed devices simultaneously, the second large letter supply device Zuf-Gb.2 and the second large letter feed device E-E.2 also operate in the second sorting pass. Otherwise, only one large letter supply device, in this case that is to say Zuf-Gb.1, and only one large letter feed device, in this case that is to say E-E.1, are used in the second sorting pass. By contrast, in the first sorting pass, both large letter supply devices Zuf-Gb.1, Zuf.Gb-2 and both large letter feed devices E-E.1, E-E.2 are used, but not the sequence production device E-E.3.

Either each sequence or each large letter is taken by a holding apparatus Hv.1, Hv.2, . . . to a buffer store Zw-Sp.1, Zw-Sp.2, . . . , as described above, and slides out of the holding apparatus into the buffer store. From this buffer store, the sequence or the large letter later slides onto the selected large letter sorting output, e.g. into the container Beh.1, Beh.2 on the selected section.

In this way, the standard letters and the large letters are arranged in a single order and thereby sorted on the basis of the prescribed sorting feature value order among the possible or else actually used delivery addresses. The mail items within a large letter sorting output, that is to say within a container, for example, have been sorted on the basis of the sorting feature value order. The large letter sorting outputs are arranged in an order, and the mail items in the order of these large letter sorting outputs have been sorted accordingly.

The same arrangement according to the solution can be used for various numerical ratios of standard letters to large letters. This ratio can vary between 2:1 and 5:1, for example. This ratio can vary from mail service provider to mail service provider and, in the case of the same mail service provider, also from day to day.

A first refinement is used when the ratio is below a prescribed ratio limit, e.g. is less than three standard letters to one large letter. The sorted standard letters are transported to the stack formation device Stp-E after the second sorting pass for standard letters has concluded fully.

A second refinement is used when the ratio is above the ratio limit, that is to say is greater than or equal to 3:1. In this case, the target sequences are transmitted to the stack formation device Stb-E and to the standard letter sorting installation Stb-Anl. The standard letter sorting installation Stb-Anl establishes for each target sequence when all standard letters whose internal identifiers make up the target sequence have been transferred out to a standard letter sorting output Stb-SAus.1, Stb-SAus.2, . . . . When this result is established, an enable signal is generated for this target sequence. If the respective enable signal is present for a prescribed number of target sequences, that sequence containing standard letters whose internal identifiers make up the target sequence is removed from the respective standard letter sorting output and transported to the stack formation device. The sequence is then fed into a holding apparatus Hv.1, Hv.2, . . . in the large letter sorting installation Gb-Anl. The second sorting pass for the remaining standard letters is continued. Hence, the following two processes are performed at overlapping times:
the second sorting pass for the standard letters on the standard letter sorting installation Stb-Anl and
the feeding of standard letter sequences into holding apparatuses Hv.1, Hv.2, . . . in the large letter sorting installation Gb-Anl.

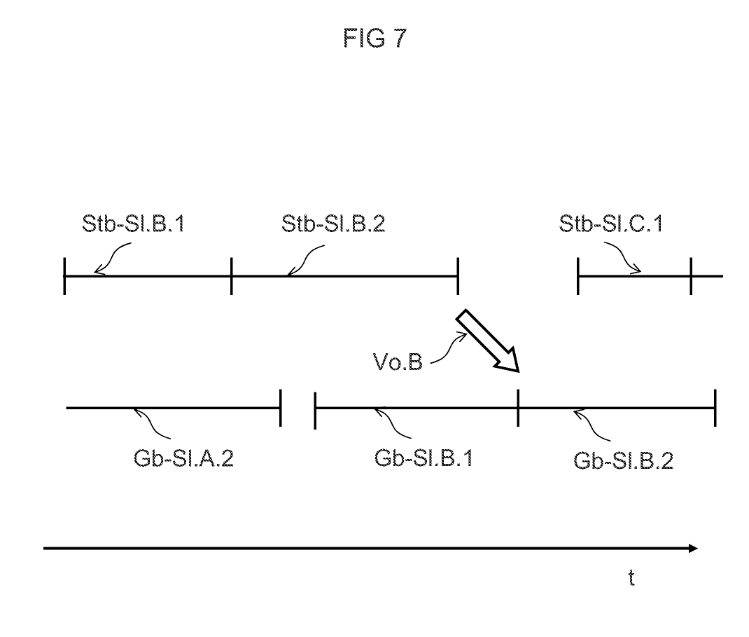

FIG. 7 to FIG. 9 illustrate different refinements for how the sorting passes in the standard letter sorting installation Stb-Anl and the large letter sorting installation Gb-Anl are synchronized. These refinements can be implemented with the same arrangement and depend on different numerical ratios of standard letters to large letters. It is possible for one refinement to be implemented on one day and for the other refinement of the synchronization to be implemented on another day. In order to match the arrangement according to the solution to these different requirements, it is merely necessary to adapt the control operations and synchronization operations of the two sorting installations Stb-Anl, Gb-Anl and the stack formation device Stp-E.

FIG. 7 to FIG. 9 each plot a time line t on the x axis. At the top, the respective start and the respective end of a sorting pass in the standard letter sorting installation Stb-Anl are shown, and those in the large letter sorting installation Gb-Anl are shown at the bottom. In all three refinements, it is first of all necessary to sort a set A of mail items, comprising standard letters and large letters, then a set B and then a set C. This is done at overlapping times.

In FIG. 7 to FIG. 9, the first sorting pass, which the standard letter sorting installation Stb-Anl performs for the standard letters in the set A, is denoted by Stb-Sl.A.1, and the second sorting pass is denoted by Stb-S1.A.2. The first sorting pass, which the standard letter sorting installation Stb-Anl performs for the standard letters in the set B, is denoted by Stb-Sl-B.1, and the second sorting pass is denoted by Stb-Sl.B.2. The first sorting pass for the standard letters in the set C is denoted by Stb-Sl.C.1, and the second sorting pass is denoted by Stb-Sl.C.2. Accordingly, the first sorting pass, which the large letter sorting installation Gb-Anl performs for the large letters, is denoted by Gb-Sl.A.1, the first sorting pass for the large letters in the set B is denoted by Gb-Sl.B.1 and the first sorting pass for the large letters in the set C is denoted by Gb-Sl.C.1. As explained above, the large letter sorting installation Gb-Anl sorts the large letters and the sequences of standard letters together in a subsequent second sorting pass. This second sorting pass is denoted by Gb-Sl.A.2 for the mail items, that is to say the large letters and the sequences, in the set A, by Gb-Sl.B.2 for the mail items in the set B and by Gb-Sl.C.2 for the mail items in the set C.

FIG. 7 shows synchronization for an average quantity-oriented ratio of standard letters to large letters. It shows the first and second sorting passes for the standard letters in the set B and the first sorting pass for the standard letters in the set C. In addition, the second sorting pass, which the large letter sorting installation Gb-Anl performs for the mail items in the set A, and the first sorting pass Gb-Sl.B.1, which the large letters sorting installation Gb-Anl performs for the large letters in the set B, are shown. The arrow Vo.B indicates the process in which the sorted standard letters in the set B are split over sequences and these sequences are transported to the large letter sorting installation Gb-Anl. FIG. 7 furthermore indicates the second sorting pass, which the large letter sorting installation Gb-Anl performs for the mail items in the set B.

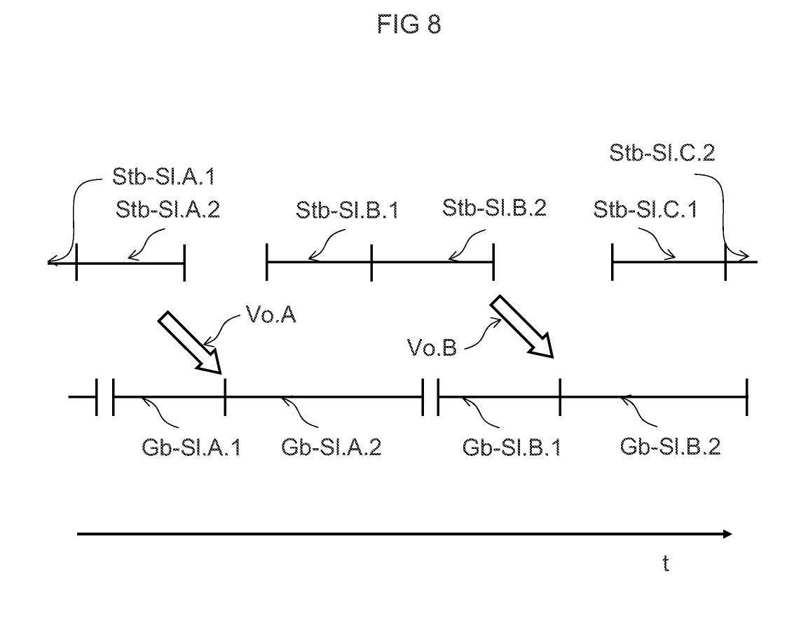

FIG. 8 shows the synchronization for the case in which a relatively large number of standard letters in comparison with the large letters need to be sorted. Therefore, the sorting passes which the standard letter sorting installation Stb-Anl performs for the standard letters last a comparatively short time. FIG. 8 shows the first sorting pass, which the standard letter sorting installation Stb-Anl performs, for the set A, for the set B and for the set C. Vo.A denotes the process in which the sorted standard letters in the set A are split over sequences and these sequences are transported to large letter sorting installation Gb-Anl. Vo.B denotes the corresponding process for the sorted standard letters in the set B. FIG. 8 also shows the two sorting passes which the large letter sorting installation Gb-Anl performs for the mail items in the set A and the two sorting passes for the mail items in the set B.

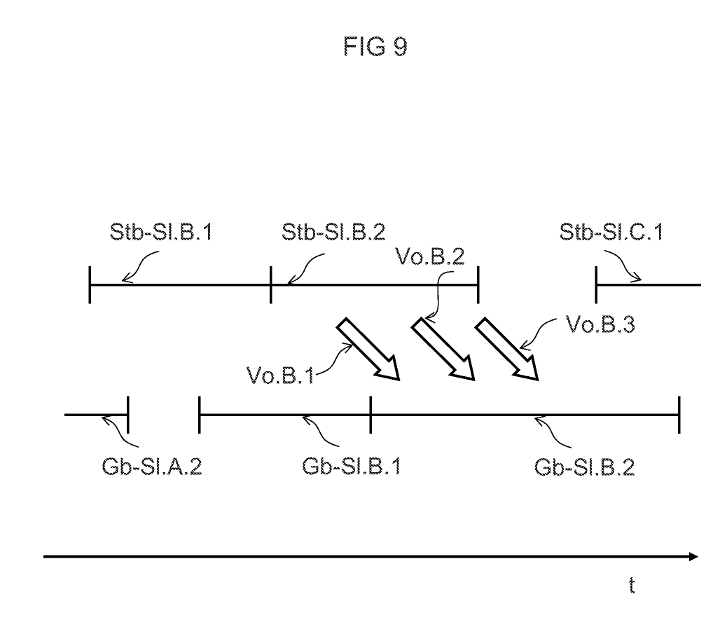

FIG. 9 shows a refinement for the situation in which a very large number of standard letters in comparison with the large letters and/or overall a very large number of standard letters need to be sorted. Therefore, the sorting passes which the standard letter sorting installation Stb-Anl performs for the standard letters last a comparatively long time. Furthermore, it is possible that the capacity of those standard letter sorting outputs which are used in the second sorting pass is not sufficient to take in all standard letters. In order to save time and in order to prevent a standard letter sorting output from overflowing, the sorted standard letters in this refinement are not first all split over sequences and transported to the large letter sorting installation Gb-Anl when the second sorting pass for the standard letters in the set B has concluded. On the contrary, three subsets B.1, B.2, B.3 of sequences of sorted standard letters in the set B are formed. The first subset B.1 containing sequences is transported from the standard letter sorting installation Stb-Anl via the stack formation device Stb-E to the large letter sorting installation Gb-Anl in the process Vo.B.1, the subset B.2 containing sequences of sorted standard letters is transported in the process Vo.B.2 and the subset B.2 containing sequences of sorted standard letters is transported in the process Vo.B.3.

Preferably, two successive subsets B.j, B.j+1 of sequences are separated by a respective separating element, e.g. actually in the standard letter sorting outputs or no later than upon being supplied to the stack formation device Stp-E.

In one embodiment, the target order Soll-R and the target sequences Seq.a, Seq.b, . . . are already produced before the mail items to be sorted have reached the arrangement according to the solution. This presupposes that the mail items to be sorted have already passed through sorting installations previously, e.g. in the case of outgoing sorting. It is possible that further mail items reach the arrangement according to the solution and are sorted after this target order and the target sequences have been produced. Preferably, it is permitted that these additional mail items are also sorted in the second sorting pass on the large letter sorting installation Gb-Anl.

In order to permit this, an extended target order is produced after these additional mail items have also passed through the arrangement according to the solution once. If an additional mail item is a standard letter, this additional standard letter passes through the standard letter sorting installation Stb-Anl, and the standard letter measuring device Ka-Stb, Bae-Stb ascertains the delivery address thereof. If the additional mail item is a large letter, the additional large letter passes through the large letter sorting installation Gb-Anl, and a large letter measuring device Ka-Gb.1, Bae-Gb.1 or Ka-Gb.2, Bae-Gb.2 ascertains the delivery address thereof. In both cases, an internal identifier for this additional mail item is furthermore produced, and a data record for this additional mail item is produced and is stored in the central data memory DSp-Ps. The original target order Soll-R is complemented by the internal identifier of this additional mail item. If the additional mail item is a standard letter, the internal identifier thereof is inserted into the appropriate target sequence. If the target sequence then becomes too large to fit into a single holding apparatus, the target sequence is divided into two target sequences. If the additional mail item is a large letter, the internal identifier thereof is inserted into the target order. This can likewise result in a target sequence being split into two target sequences, e.g. because the internal identifier of the additional large letter is situated in the center of a target sequence.

The extended target order produced in this manner and the possibly altered target sequences are transmitted to the standard letter sorting installation Stb-Anl before the standard letter sorting installation Stb-Anl performs the second sorting pass for the standard letters, and also to the stack formation device Stp-E. Both installations then produce the sequences on the basis of the altered target order Soll-R.

1. A method for sorting a plurality of articles on the basis of a prescribed sorting feature, wherein a sorting feature value order among the occurring values of the sorting feature is prescribed, and wherein each article to be sorted belongs either to a first article type or to a second article type depending on a physical property, which comprises:
providing a sorting installation having:
at least one supply and feed device, a transportation device; and at least one sorting output;
the transportation device including a plurality of holding apparatuses, with each holding apparatus enabled to hold at least one article to be sorted; and enabled to release all held articles at once;
measuring for each article to be sorted the value which the sorting feature assumes for this article;
supplying each article to be sorted to the sorting installation using a supply and feed device and taking to a holding apparatus or intermittently connecting to the holding apparatus in another way;
selecting, for each holding apparatus that is filled with at least one article to be sorted, a sorting output of the sorting installation depending on the measured sorting feature value of an article in the holding apparatus;
taking each filled holding apparatus with the transportation device to a transfer position for the selected sorting output; and
taking all articles from this holding apparatus to the selected sorting output and thereby transferring out to the selected sorting output;
performing an outward transfer such that in each sorting output used a respective article succession of articles is produced which have been sorted on the basis of the sorting feature value order;
and further:
producing a plurality of sequences of articles of the first article type such that each article of the first article type belongs to a respective sequence;
each sequence comprises at least one article of the first article type; and
the articles in a sequence all belong to the first article type, producing each sequence containing articles of the first article type such that the articles within this sequence are sorted on the basis of the prescribed sorting feature value order;
wherein at least one sequence includes at least two articles with a matching sorting feature value or two articles with two sorting feature values that occur in direct succession in the sorting feature value order;
taking all sequences of articles of the first article type and all articles to be sorted of the second article type to holding apparatuses such that,
when they have been taken, each filled holding apparatus contains a respective sequence of articles of the first article type or at least one respective article of the second article type;
transferring all articles in a sequence out to the same sorting output.

2. The method according to claim 1, which comprises:
for each sorting feature value assumed by a plurality of articles to be sorted of the first article type, producing at least one respective sequence which comprises two of these articles with a matching sorting feature value.

3. The method according to claim 1, which comprises:
producing at least one sequence such that
this sequence includes at least one article with a first sorting feature value and at least one article with a second sorting feature value;
wherein the two sorting feature values differ from one another; and
no article of the second article type has a sorting feature value arranged between the first sorting feature value and the second sorting feature value in the sorting feature value order; and
taking all articles in this sequence to the same holding apparatus.

4. The method according to claim 1, which comprises:
providing the sorting installation with:
at least one first supply and feed device for articles of the first article type; and
at least one second supply and feed device for articles of the second article type;
filling the holding apparatuses used with articles to be sorted such that
each sequence produced is taken to a holding apparatus by a first supply and feed device; and
each article to be sorted of the second article type is taken to a holding apparatus by a second supply and feed device.

5. The method according to claim 4, which comprises:
performing the two steps wherein
at least one first supply and feed device takes the sequences to holding apparatuses and
at least one second supply and feed device takes the articles of the second article type to holding apparatuses
with a temporal overlap.

6. The method according to claim 5, wherein:
the sorting installation has a plurality of sorting outputs;
the sorting installation distributes the articles of the second article type over these sorting outputs in a preceding sorting pass depending on the measured sorting feature values of these articles;
in the preceding sorting pass, the first supply and feed device is not used for articles of the second article type; and
the articles of the second article type which are distributed over the sorting outputs are supplied to the sorting installation again by way of at least one second supply and feed device.

7. The method according to claim 6, wherein:
the sorting installation has a second supply and feed device for the articles of the second article type; and
for the preceding sorting pass the articles of the second article type are supplied to the sorting installation exclusively via the at least one second supply and feed device.

8. The method according to claim 1, wherein:
each sorting output used includes a support area for articles to be sorted;
the step of taking a holding apparatus to a transfer position for a sorting output with the transportation device further comprises:
a step that the transportation device takes the holding apparatus to a position perpendicularly or obliquely above the support area; and
that step of taking all articles from this holding apparatus to this sorting output further comprises:
a step of conveying the holding apparatus to a release position whereupon all articles slide from the holding apparatus onto the support area or into a container disposed on the support area.

9. The method according to claim 1, which comprises transporting at least one set of sequences to a supply and feed device before the step of dividing all articles of the first article type into sequences is complete.

10. The method according to claim 1, which comprises:
for each article to be sorted, producing a computer-accessible internal identifier;
before the sequences are produced, using a data processing installation to generate a target order among the internal identifiers such:
that in the target order the internal identifiers are sorted on the basis of the sorting feature value order and the measured sorting feature values for the respectively associated articles, and
producing each sequence of articles of the first article type such that:
in the target order, the internal identifiers of the articles in the sequence are in direct succession; and
no internal identifiers for an article of the second article type occur between the internal identifiers of the articles in the sequence.

11. The method according to claim 1, which comprises:
in advance, causing a sequence production device to use a further sorting installation to sort the articles of the first article type depending on the measured sorting feature values of these articles and the sorting feature value orders;
splitting these articles with the sequence production device into the sequences during sorting; and
taking each sequence thus produced to a first supply and feed device.

12. The method according to claim 1, which comprises:
transporting the holding apparatuses used along a closed conveying path with the transportation device, and
during the transportation of a holding apparatus used along the closed conveying path, performing both:
the step of filling the holding apparatus with at least one article; and
the step of transferring all articles in the holding apparatus out to the same sorting output.

13. A configuration for sorting a plurality of articles based on a prescribed sorting feature, wherein a sorting feature value order among the occurring values of the sorting feature is prescribed, and each article to be sorted belongs either to a first article type or to a second article type depending on a physical property thereof, the configuration comprising:
a measuring device, a sorting installation, and a sequence production device;
said sorting installation including at least one supply and feed device, a transportation device, and at least one sorting output;
said transportation device having a plurality of holding apparatuses each configured:
to intermittently take in at least one article to be sorted or to intermittently hold the at least one article in another way; and
to release all held articles at once;
said measuring device being configured to measure, for an article to be sorted, the value assumed by the sorting feature for the article;
each said supply and feed device being configured to take articles to be sorted to holding apparatuses or to intermittently connect the articles to holding apparatuses in another way;
said sequence production device being configured to produce a plurality of sequences of articles of the first article type such that
each sequence includes at least one article of the first article type;
the articles in each sequence are inherently sorted on the basis of the sorting feature value order; and
each article in each sequence belongs to the first article type,
wherein the configuration is configured to perform, for each article to be sorted, the following steps:
measuring, with the measuring device, the value which the sorting feature assumes for the respective article, and
using a supply and feed device, supplying the article to the sorting installation and taking the article to a holding apparatus or to intermittently connect the article to the holding apparatus in another way;
wherein the configuration is further configured to select, for each holding apparatus that is filled with at least one article to be sorted, a sorting output of the sorting installation depending on the measured sorting feature value of an article in the respective holding apparatus;
said transportation device being configured to take each filled holding apparatus to a transfer position for the selected sorting output;
wherein the configuration is further configured to take all articles from a respective said holding apparatus that is in a transfer position for a selected sorting output to said sorting output and thereby to transfer them out to said selected sorting output;
wherein the configuration is configured to perform the outward transfer of the articles to be sorted such that in each sorting output used a respective article succession of articles to be sorted which have been sorted on the basis of the sorting feature value order is produced;
wherein the configuration is also configured to use said sequence production device to split the articles to be sorted of the first article type into sorted sequences, such that
each article to be sorted of the first article type belongs to a sequence; and
at least one sequence produced comprises at least two articles with a matching sorting feature value or two articles with two sorting feature values which occur in direct succession in the sorting feature value order;
wherein the configuration is also configured to use the at least one supply and feed device to take all produced sequences of articles of the first article type and all articles to be sorted of the second article type to holding apparatuses such that, when they have been taken, each filled holding apparatus contains
a respective sequence of articles of the first article type, or
a respective at least one article to be sorted of the second article type,
wherein the configuration is also configured to transfer articles to be sorted out to sorting outputs such that, after the outward transfer, all articles in a sequence are situated in the same sorting output.

14. The configuration according to claim claim 13, wherein:
said sorting installation comprises
at least one first supply and feed device for articles of the first article type; and
at least one second supply and feed device for articles of the second article type;
said holding apparatuses are filled with articles to be sorted such that
at least one first supply and feed device takes the sequences to a respective holding apparatus; and
at least one second supply and feed device takes the articles of the second article type to a respective holding apparatus.
